(19) United States
(12) Patent Application Publication
(10) Pub. No.: US 2007/0047707 A1
(43) Pub. Date: Mar. 1, 2007

(54) IP-enhanced cellular services

(75) Inventors: Daniel J. Mayer, Warren, NJ (US); Alan V. Staniforth, East Brunswick, NJ (US)

Correspondence Address: DAVIDSON BERQUIST JACKSON & GOWDEY LLP, 4300 WILSON BLVD., 7TH FLOOR, ARLINGTON, VA, 22203, US

(73) Assignee: NET2PHONE, INC., Newark, NJ (US)

(21) Appl. No.: 11/211,644

(22) Filed: Aug. 26, 2005

(51) Int. Cl. H04M 15/00

(52) U.S. Cl. 379/114.28; 379/111

(57) ABSTRACT

A federation of multinational PSTN, IP and cellular service providers coordinate their accounting by: populating a subscriber database of subscribers to one number services, a service providers database and a payments clearing database having amounts owed across the service providers based on the individual service provider's portion of pre-agreed payments for services; collecting accounting data from the service providers; updating the relevant databases with the data collected; and providing accounting data to the service providers and subscribers. Voice over IP service is applied to a cellular phone by selecting a compatible codec at peripheral gateways of IP network paths, thereby avoiding transcoding by a connecting multimedia terminal adapter. A portable module, multimedia terminal adapter cellular internet protocol gateway for media communications over an IP network (MTAC IPG) bridges a cellular network, an IP network and a PSTN so that a user may locally dial a cellular phone that is then used to enter the IP network and dial the called party. The MTAC IPG provides gateway functionality and packetizing.

### CROSS-REFERENCE TO RELATED APPLICATIONS

The present application is related to co-pending applications entitled “MTA-CRADLE PERSONAL GATEWAY” and “IP-ENHANCED CELLULAR SERVICES,” U.S. application Ser. No. ______ (Attorney Docket No. 2655-0009) and U.S. application Ser. No. ______ (Attorney Docket No. 2655-0010), respectively, filed on even date herewith. The contents of those applications are incorporated herein by reference.

### BACKGROUND OF THE INVENTION

1. Field of the Invention

The invention relates to the use of a MTA (Multimedia Terminal Adapter), phones and cellular communication devices for establishing and conducting call sessions over Public Switched Telephone Networks (PSTN), cellular networks, and packet (e.g., IP) networks.

2. Description of the Related Art

Prior to the present invention, the interrelationship between Voice over Internet Protocol (VoIP) and Cellular telephony was contextualized around voice over Wireless Local Area Network (WLAN) and dual-mode devices (devices that communicate through cellular and WLAN networks). Related technology centered on one-number (including follow-me) services in which VoIP service providers (e.g., AT&T CallVantage, Vonage, etc.) permitted their customers to set up one-directional call redirection (from IP to cellular) based on specific customer-set preferences. Cellular-to-IP redirection is not a common part of one-number or follow-me arrangements. The one-number service is important because it tends to add “stickiness” to telecommunications services. Stickiness in this context refers to a customer's reluctance to drop the subscription to a particular service. For example, maintaining the association with a phone number (that is well known by business associates, friends, and family) is a “sticky” feature.

International travelers who value mobility may rent cellular phones abroad, and may further reduce the cost of international calls by supplementing the cellular phones with calling cards. A traveler who subscribes to VoIP services and obtains an MTA (Multimedia Terminal Adapter), may under certain circumstances carry the MTA to remote international locations, and plug the MTA into a broadband-network outlet, thus enabling inexpensive communications to or from the remote country by using VoIP. The MTA has the additional advantage of enabling the subscriber to be associated with a single phone number regardless of the subscriber's location. However, the traveling subscriber must have access to the broadband-plugged MTA to make or receive VoIP calls. Thus, the MTA does not provide the same degree of mobility that a cellular phone does. Rented cell phones also are not associated with the traveler's “reach” telephone number. Travelers provide their temporary foreign cellular phone number to associates who use it for the duration of the trip. Certain countries (e.g., India) have outlawed the use of phone-to-phone VoIP services by prohibiting the installation and operation of formally established local VoIP Gateways.

Current solutions provide only a fraction of the possible synergistic features attainable by interrelating cellular services and packet telephony. Most current solutions forward incoming packet-telephony calls to a subscriber's cellular phone based on a set of predefined rules. Other solutions address the combination of cellular telephony and VoWLAN (Voice over Wireless LAN), mostly through the use of dual-mode wireless devices.

### SUMMARY OF THE INVENTION

The present invention accelerates telephony service convergence by leveraging the advantages of the individual telephony technologies. More particularly, one embodiment includes an MTA/Cellular (MTAC) device having a cradle (or other power/signaling/media connection equipment for a cellular device), and a platform, which includes at least part of a service platform and optionally also databases. A platform, as used herein, includes one or more of software (including operating systems, applications and databases) and hardware (including switches, controllers/processors, input/outputs, and databases) to enhance an MTA for enabling the disclosed features and functions of the present invention.

As used herein, the term cellular phone shall be used in lieu of the term “cellular device”. “Cellular phone” includes such equivalent terms as cellphone, cell-phone and cellular telephone. Corresponding devices may have: dual functions of analog and/or digital media and signaling; video and still picture capture, transmission and reception; streaming audio and/or video; data file handling; and other multimedia capabilities.

Additional interrelationships between cellular and Internet Protocol (IP) services are especially important in view of the present and expected competition between regional telephone companies and cable providers. For example, some regional telephone companies operate their own cellular services (e.g., Verizon). This enables them to offer “triple-play” bundles of wireless and wireline communications along with Digital Subscriber Line (DSL) broadband internet access. By at least partly solving this problem of needed interrelationships between cellular and IP services, the present invention provides cable companies with an incentive to partner with cellular carriers, or become Mobile Virtual Network Operators (MVNOs). Such cooperation enables the offering of a “quadruple play”—a bundle of television, broadband, telephony, and cellular services.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 depicts a user environment using conventional components, taken from the viewpoint of the communication service users, which figure is useful in identifying problems in and analyzing the causes of such problems of known systems, which identifying and analyzing are part of the present invention;

FIG. 2 depicts another known user environment, taken from the viewpoint of the communication service users, which figure is useful in identifying problems in and analyzing the causes of such problems of the known system, which identifying and analyzing are part of the present invention;

FIG. 3 depicts an environment of one or more subscribers to the present embodiment, taken from the viewpoint of the subscribers, who are the communication service users, according to an embodiment of the present invention;

FIG. 4 depicts components of the subscriber environment of the present embodiment, particularly the MTAC Cradle and the separate, partially built-in, or built-in platform enabling features provided by the present embodiment in interacting with various networks;

FIG. 5A depicts a cellular device, particularly a cellular phone, nestled in an MTAC Cradle according to one embodiment, with the cellular phone having an electrical connection with the MTAC Cradle via a physical plug that unplugs upon removal of the cellular phone;

FIG. 5B depicts the electrical connection between the MTAC Cradle and the cellular phone and showing a cord that is part of the connection;

FIG. 5C depicts an electrical connection for interconnecting the MTAC Cradle with the cellular phone and showing a cordless connection that is part of the interconnecting of the cellular phone and the MTAC Cradle;

FIG. 6 is a schematic representation of the interface between the MTAC Cradle and the cellular phone, which in one embodiment is the electrical connections of FIGS. 5A and 5B for wire link and cordless connections;

FIG. 7 is a flow diagram of the operation of one embodiment, wherein the MTAC Cradle, platform and cellular-phone registration process extends the service internationally;

FIG. 8 is a flow diagram of the operation of one embodiment of a Service Platform controlling the making of outgoing calls, from the Subscriber Environment, when the cellular phone is in the MTAC cradle;

FIG. 9 is a flow diagram of the operation of one embodiment of a Service Platform controlling the making of outgoing calls, from the cellular phone 307, when the cellular phone is not in MTAC Cradle 305;

FIG. 10 is a flow diagram of the operation of one embodiment of a Service Platform controlling incoming calls to the subscriber's “one number”;

FIG. 11 is a flow diagram of the operation of one embodiment functioning as a personal gateway;

FIG. 12 shows the MTAC IPG (IP Gateway) Cradle as a personal, multimedia IP communications (VoIP) portable gateway, which can accompany the subscriber abroad;

FIG. 13 shows a known MTA IPG;

FIG. 14 shows further details of a MTAC IPG Cradle 1430, which is similar to MTAC IPG Cradle 1230, but additionally includes a built-in DSL modem supplanting or supplementing broadband connectivity mechanisms such as Ethernet.

FIG. 15 is a schematic showing of the functionality of an International Service Federation or Clearinghouse to coordinate the use of an MTAC IPG Cradle domestically and when traveling abroad;

FIG. 16 is a schematic representation of the major components of the MTAC IPG Cradle; and

FIG. 17 is diagram of a cellular network which improves quality of service by reducing the number of end-to-end transcodings stages performed within the system.

### DETAILED DESCRIPTION OF THE PREFERRED EMBODIMENTS

Referring now to the drawings, wherein like reference numerals designate identical or corresponding parts throughout the several views.

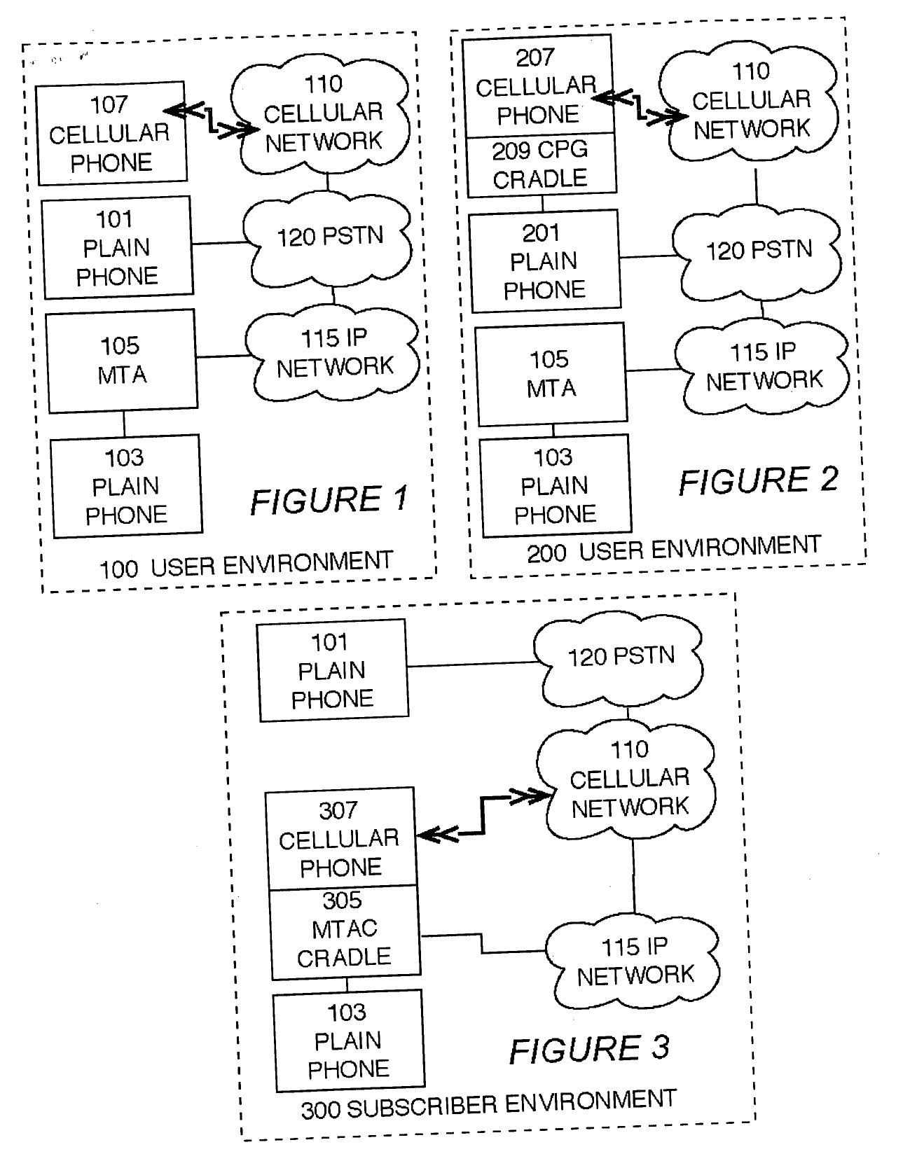

The user environments depicted in FIGS. 1 through 3 are not intended to connote completeness. For the purpose of those figures, such user environments constitute an exemplary subset of the access and devices useable with the present invention. A more detailed configuration of the environments of FIGS. 1 to 3 would include additional devices such as PCs and other home-networked devices. These additional devices, when present, are connected through a wired or wireless LAN and a router or a switch (not shown).

FIG. 1 depicts a user's telecommunication access environment 100 that includes a plain telephone 101 (aka a POTS telephone) connected to the PSTN 120, a cellular phone 107 connected to a cellular network 110, and another Plain Telephone 103 connected to the PSTN 120 by way of a MTA 105 and an IP-network 115. Cellular phone 107 communicates using at least one desired session type, e.g. voice, messaging, web, and audio or video streaming. Alternatively, Plain Telephones 101 and 103 may instead be single, 2-line instruments, where one line is connected to the MTA, and the other is connected directly to the PSTN (using an analog or ISDN connection).

MTA 105 may make Plain Telephone 103 the equivalent of a Session Initiation Protocol (SIP) phone, such as a Voice over Internet Protocol (VoIP) phone conforming to the description in the Internet Engineering Task Force (IETF) Request For Comment (RFC) 3216 and related RFCs. Phone 103 (or phone 103 and MTA 105) may alternatively be a general-purpose computer with correspondingly conforming software. The access to Internet Protocol (IP) Network 115, a special case of packet networks in general, may be provided through a wired or wireless transmission link. In the end-user environment of FIG. 1, separate relationships are usually established with the providers of each network (packet IP Network 115, Public Switched Telephone Network (PSTN) 120, and Cellular Network 110).

In certain cases, service providers offer cross-access-networks synergistic value. For example, based on a user-tunable set of rules, some providers of packet telephony permit the redirection of incoming calls to the user's cellular phone through the cellular network 110. Currently known MTAs permit selecting the access network used for outgoing calls between packet-network 115 and PSTN 120, with access depending on the MTA switch settings and/or a user-tunable set of rules. These rules allow the user to trade off quality of service (QoS) and cost, and to conduct multiple concurrent sessions from the user environment 100 (e.g., when using both lines of a two-line phone or two separate single- or two- line phones).

FIG. 2 depicts another user's telecommunication access environment 200 that includes additional known devices. A Cellular-PSTN Gateway (CPG) cradle 209 is provided for the user's cellular phone 207. Known CPG cradles include CellSocket, PlugCell, RCA Cell Docking System, and Dock-N-Talk. A CPG cradle enables one or more plain telephones 201 to communicate via the cellular network 110 in order to take full advantage of cellular service pricing packages. In one arrangement, the user foregoes PSTN services altogether by disconnecting the link between the plain telephone 201 and the PSTN 220, and then using the CPG cradle 209 to enable all incoming and outgoing communications over the cellular network 110. The CPG cradle 209 is directly connected to plain telephone 201 by a physical wire transmission link (wireline), thereby providing gateway functions suitable for using the cellular network 110 (through cellular phone 207) from or to the plain telephone 201. CPG Cradle 209 is typically used for both incoming and outgoing calls, and a direct electronic connection between the cradle and the cellular phone permits both pushbutton signaling and voice communications to be transmitted between the devices.

In another arrangement, plain telephone 201 is connected via one transmission link for one number to PSTN 120 and another transmission link for another number to CPG Cradle 209, which permits, via toggle or pushbutton, access to two or more phone lines, thereby availing the user of the choice between communicating via a cellular network 110 or the PSTN 120 network on a call-by-call basis. A similar arrangement can be provided by a multi-line plain telephone connected to the CPG cradle 209 with one line, and to the PSTN 120 with the other. Separate access to IP Network 115 (and its associated paraphernalia 103, 105) is optional, and this access may be used to reduce user communications costs under appropriate conditions, and/or to enable communications with the (residential or business) facility when the cellular phone 207 is not nestled in CPG Cradle 209 (e.g., when the user carries the cellular phone away from the physical facility), especially if plain telephone 201 is not connected to the PSTN 120.

Another feature embedded in the CPG cradle 209 may include cellular phone battery charging. A second type of cradle (e.g., Cingular's FastForward) provides incoming-call rerouting capabilities by providing cellular hand-set presence information through the cellular network without providing gateway functionality. That is, incoming calls may be redirected to plain telephone 201 via the PSTN 120 as described in association FIG. 1. However, this second type of cradle is not connected to plain telephone 201 but rather relies on switching related to the cellular network 110 to forward the incoming call via PSTN 120.

FIG. 3 depicts the user's environment 300 of the present embodiment. Cellular phone 307 is shown placed in an MTA/Cellular (MTAC) Cradle 305. The MTAC Cradle 305 is connected to the IP Network 115 via a broadband connection. Broadband (exemplary forms of which are via cable, DSL, or wired/wireless alternatives) connotes a connection (always-on) with sufficient bandwidth & quality of service (QoS) for the desired communication sessions to be made possible by the MTAC Cradle 305. Plain telephone 101 and PSTN 120 connectivity, however, are not necessary. Plain Telephone 101 and Plain Telephone 103 may be a single, 2-line Plain Telephone 103, where one line is connected to the PSTN 120, and the second to MTAC cradle 305. A modification of the FIG. 3 environment is obtained by replacing the plain telephone 103 and MTAC Cradle 305 by an integrated SIP phone and MTAC Cradle (collectively, also a MTAC Cradle 305), which has a similar cellular-device cradle. Also, the MTAC Cradle 305 may be constructed of the MTA 105 that is modified to connect to a peripheral cellular phone cradle (not shown).

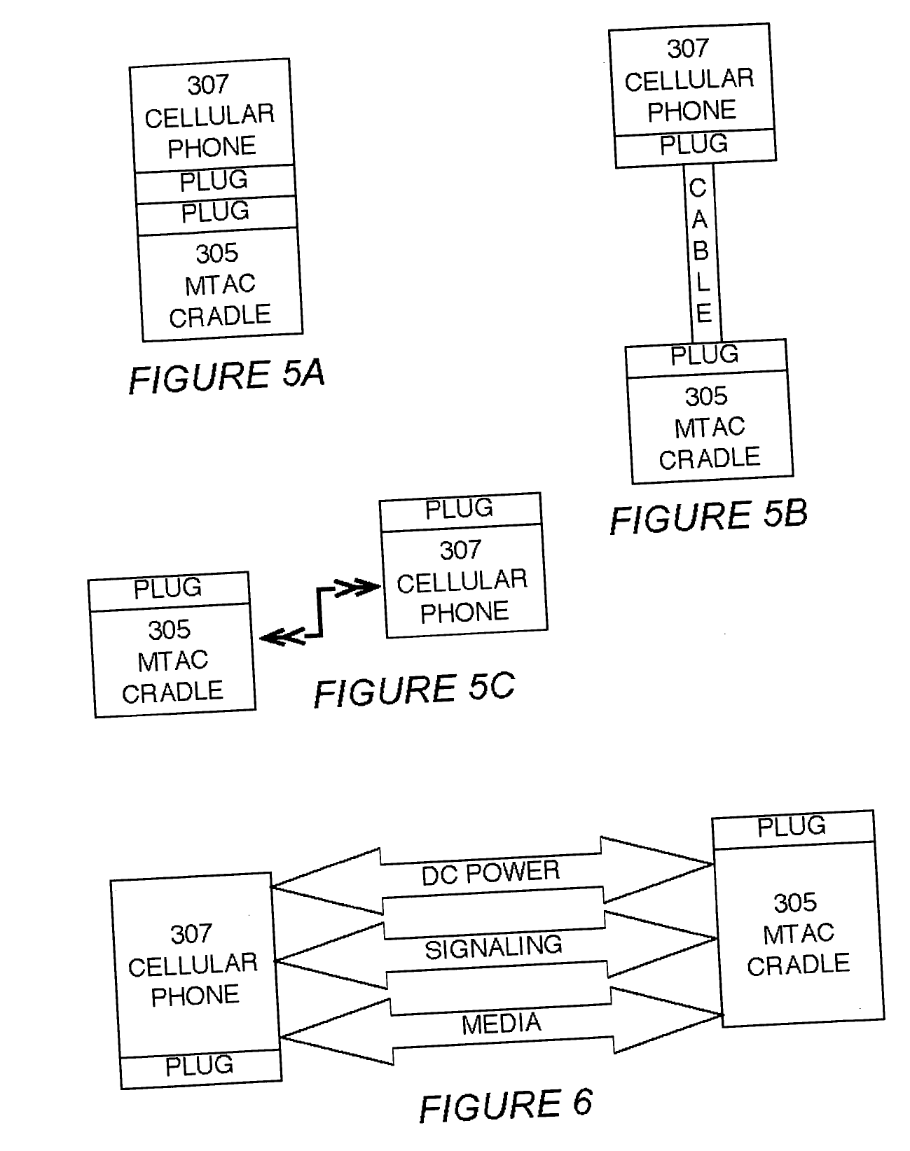

The MTAC Cradle 305 establishes or determines the presence of the cellular phone 307. Herein, the presence refers to the cellular phone being within operatively connected distance to the MTAC Cradle 305 as described with respect to FIG. 5A, 5B, 5C for transmission and reception, i.e. exchange, of signaling and media as described with respect to FIG. 6. Presence determination may be by sensing the occurrence of the wired or cordless signaling of FIG. 6. Sensing may be of (1) a change in current or voltage of the DC power, (2) the cellular phone 307 being in the MTAC Cradle 305 as in FIG. 5A or otherwise operatively electronically connected as in FIGS. 5B and 5C, (3) the manual activation of a switch on MTAC Cradle 305, and/or (4) automatically through a form-factor activated switch in the MTAC Cradle 305. Form-factor activation may constitute a micro-switch activated by the cellular phone weight or the pressure exerted by the cellular phone 307 when nestled in MTAC Cradle 305, or by a change in capacitance caused by the presence of the cellular phone 307. Form-factor activation, capacitance sensing and manual switching are not as secure for establishing presence as the other ways, since they neither identify the nestled object as a cellular phone, nor authenticate particular cellular phones.

When presence is determined, presence information is communicated over the IP Network 115 or by the cellular phone 307 over the cellular network 110 (e.g., via a Short Message Service (SMS)) to a back-end infrastructure. The presence information may include authentication and functionality identification, for example a unique user code, a model number, a serial number or codec capabilities. By way of example, a user code or device number may be used to indirectly convey functionality identification, such as a cellular phone built-in codec capability.

The electronic connection between the cellular phone 307 and the MTAC Cradle 305 is established through a physical plug (FIG. 5A directly or FIG. 5B with an intervening cord, for example) or through a cordless transmission link (FIG. 5C, for example), such as a very-short-range wireless transmission link. Such very-short range links include Bluetooth links, conforming to the Institute of Electrical and Electronics Engineers (IEEE) standard 802.15.1 (IEEE 802.15.1) for Personal Area Network technology. Moreover, additional technologies may be used for cordless transmission, including Radio Frequency Identification (RFID), and Infrared. RFID standards are discussed in materials of the Association for Automatic Identification and Mobility. The electronic connection between the cell phone 307 and the MTAC Cradle 305 enables the flow of DC power (by induction in the cordless case for battery charging or operation), signaling, and media (i.e. information, e.g., computer data, audio or video streaming, graphics, and voice), as shown in FIG. 6.

The MTAC Cradle 305 enables the subscriber to make and receive calls via the cellular network 110; the MTAC Cradle 305 is used to access the cellular phone 307, thereby providing functionality similar to that of the CPG Cradle 209 of FIG. 2. When functioning in this manner, the MTAC Cradle does not process voice/media for delivery over the IP Network 115, i.e. it does not provide VoIP functionality.

A less capable version of the MTAC Cradle 305 does not provide media connectivity to the cellular phone 307. The cradle of the less capable version of the MTAC Cradle 305 merely provides cellular phone charging capability (DC power or inductive means in FIG. 6) and cellular phone presence detection. Such presence may be established in the manner discussed above. Except for providing for access to VoIP services, this less-capable MTAC Cradle 305 has functionality that is similar to the functionality of the Cingular's FastForward. However, the less-capable MTAC Cradle 305 transmits presence and forwarded-phone number information to the forwarding server platform through the IP network 115, thus eliminating the need for specialized cellular-phone applications.

MTAC Cradle 305 differs from the usual MTA 105 in additional important aspects. For example, plain telephone 103 can access the cellular network 110 by passing its analog media stream and signaling information (e.g., Dial Tone Multi-Frequency (DTMF)) directly through the MTAC Cradle 305 to cellular phone 307, and when this happens, the MTAC Cradle 305 bridges the plain telephone 103 and cellular phone 307 directly without using the MTAC's gateway functionality. That is, the media of the plain telephone 103 is neither encoded nor packetized by the MTAC Cradle 305 when being delivered to/from the cellular phone 307, and the IP network is not used. In the preferred embodiment, the MTAC Cradle 305 includes a display screen and appropriate user inputs to ease the subscriber's experience of service programming and option selection, i.e., to make the MTAC Cradle 305 user friendly.

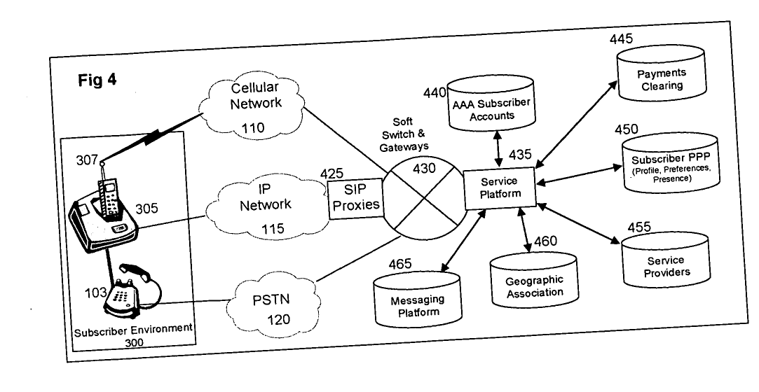

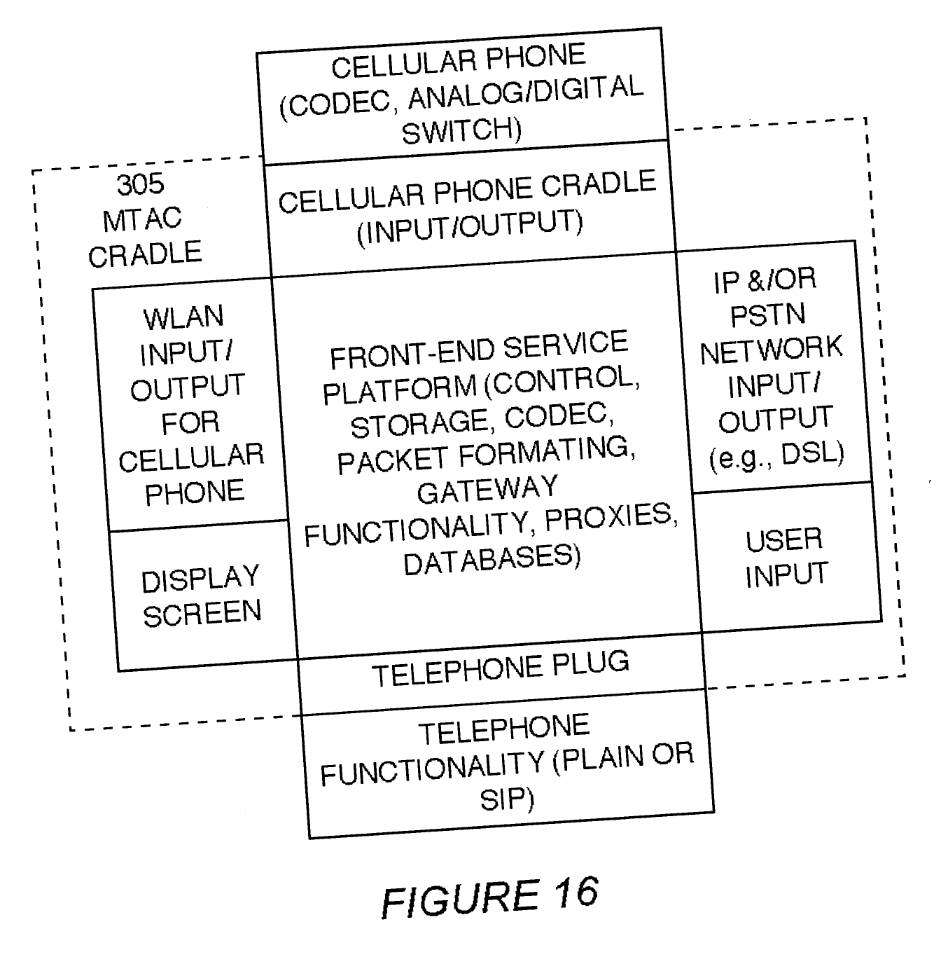

The preferred embodiment also permits the authenticated online subscriber to attend to various aspects of the service (mainly subscriber-alterable fields in the Subscriber Profile, Preferences, Presence (PPP) database 450 of FIG. 4), through an online PC, the built-in display and user input (e.g. a keyboard) of FIG. 16, or equivalent device that is independent from the MTAC Cradle 305. In an alternative embodiment, an offline PC may be used for this purpose when connected directly to the MTAC Cradle, e.g., through a USB connector.

FIG. 4 depicts the major components of the subscriber environment of one embodiment, and an exemplary platform. Platforms are one or more of the application and other functional software, operating system and hardware.

The conventional “user environment” of FIGS. 1 and 2 is transferred into a “subscriber environment” in FIGS. 3 and 4 by utilizing an MTAC Cradle 305 and a subscription.

The illustrated embodiment enables a subscriber to advertise a single reach identification, for example a reach address or reach number, which could be an Internet Protocol (IP) address or a telephone number. The cellular device might be a cellular phone (reachable by number), or multimedia devices that include data capabilities such as a Short Message Service (SMS), e-mail, Web access, etc. A more general example of reach identification is a Session Initiation Protocol (SIP) Address. The reach identification, address or number is registered to one or more providers of IP-based communication services, e.g., a VoIP service provider or an Internet Service Provider (ISP), and is stored in Service Providers database 465 with an index to the subscriber PPP database 450.

Examples of multiple providers of IP-based communication services where the same unique identification may be registered are the providers of VoIP services and of value-added applications on top of VoIP that are distinct. The registration is an example procedure for assuring that all incoming sessions are processed by the Service Platform 435. In this preferred embodiment the user/subscriber may bring a pre-existing reach number identification (e.g., telephone number) to the service. Identification and/or authentication may be assigned to a new subscriber upon request.

As shown in FIG. 4, a SoftSwitch is a type of switch capable of both circuit and packet switching, for use over the PSTN and, for example, IP Networks, respectively. A gateway is an electronic intermediary that intercepts and steers electronic signals from one network to another, which in addition may perform signal shaping and code or protocol conversion between otherwise incompatible networks. The SoftSwitch and Gateways 430 provide session routing and bridging capabilities across the three networks shown, that is the: Cellular Network 110, IP Network 115 and PSTN 120. (Bridging permits the parking of incoming or outgoing call legs and then connecting (bridging) them with one or more other outgoing or incoming legs of the call/session.) The gateways need not be collocated with the SoftSwitch, but rather could be distributed in a convenient manner along the media paths of communications, particularly where dissimilar networks intersect. In the exemplary embodiment, the SoftSwitches are collocated with the gateways. Whether collocated with the SoftSwitch or not, it is preferable that the media gateways are under the direct control of the SoftSwitch and SIP Proxies 425.

At least one SIP Proxy 425 interoperates with MTAC Cradle 305 (e.g. with a SIP phone) according to the SIP standards as defined in Request for Comments (RFC) 3261 and related RFCs. Both SoftSwitch 430 and the at least one SIP Proxy 425 operate under the control of Service Platform 435.

Whether the following databases are wholly or partially front-ended by being within the MTAC Cradle 305 as in FIG. 16 or wholly or partially back-ended by being external to and connected by the IP Network 115 to the MTAC Cradle 305 as shown in FIG. 4, the Service Platform 435 proxies of FIG. 16 communicate with several databases for populating them, and storing, altering and retrieving data.

The AAA (Authentication, Authorization and Accounting) Subscriber Accounts database 440 maintains subscriber service-usage and billing information. Where necessary (e.g., when components of the service are provided by others), AAA Subscriber Accounts database 440 interfaces with similar systems dedicated to cellular service providers, PSTN service providers, and perhaps other, value-added service providers. Current AAA solutions focus on Remote Authentication Dial-In User Service (RADIUS) and its follow-on Diameter protocols. The Service Platform 435 uses the AAA Subscriber Accounts database 440 to ensure that the user is a subscriber in good standing, and to record all billable transactions as they occur and thus includes one or more databases that are remote or resident with respect to the MTAC Cradle 305. The AAA Subscriber Accounts database 440 is preferably used to produce billing documents and to record subscriber payments in cooperation with the database Payments Clearing 445. The reach identification may be a key to the AAA Subscriber Accounts database 440.

The Subscriber PPP (Profile, Preferences & Presence) database 450 contains all subscriber-specific information. It is populated upon service provisioning and is maintained by the subscriber as profile and preferences change. As verified and approved by the service provider, subscriber access preferably is accomplished through the World Wide Web (WWW, which is an application of the IP Network 115). In other preferred embodiments, the subscriber may use interactive-voice response systems and/or other information providing and updating means like SMS. The latter is aided by the added mode of subscriber authentication enabled by associating the updating cellular device with the Subscriber PPP database 450. The Subscriber PPP database 450 includes details of terminal equipment (e.g., handsets) used by the subscriber, services subscribed to (e.g., one number or follow-me routing), geographic location of user devices (permanent and temporary), subscribed services & packages, subscriber rules of service behavior under specified conditions, and other relevant details. Subscribers to the service obtain secure authentication means upon service provisioning. Subscribers are permitted to access certain portions of the Subscriber PPP database 450 to populate and alter their profile and preferences data. The systems protect against all other access, data contamination, or denial-of-service attacks by known means. The reach identification may be a key to the Subscriber PPP database 450.

The Service Providers database 455 contains the details of all service providers participating in the integrated service packages made available to the subscribers, for example, services by PSTN carriers, VoIP service providers, cellular carriers, and geographic-association service providers. Though, in the illustrated embodiment, the service is described from the viewpoint of a VoIP primary carrier or integrator, the illustrated embodiment is exemplary and the illustrated embodiment is not meant to limit the primary service provider to any one or combination of specific service providers, perhaps including roaming-service providers.

The illustrated embodiment uses the subscriber's identification associated with the incoming calls, for example the subscriber's well-advertised reach number, which has been assigned so as to route calls via the Service Platform 435. The Service Platform 435 operator would usually be a VoIP carrier or value-added service provider. Local service providers with whom agreements are desired include broadband access providers and cellular carriers or resellers.

The Payments Clearing database 445 keeps track of amounts owed across Service Providers based on the individual service provider's portion of pre-agreed payments for services.

Periodically, the amounts owed across Service Providers are trued and payments tracked by processes performed by the Service Platform 435. Where payments are not cleared within contracted periods, data within the Payments Clearing 445 database causes the Service Platform 435 to remove the offending service provider from available Service Providers database 455, and thereby the Service Platform 435 stops assigning services to that removed service provider until the situation is cleared up and the removed service provider is re-entered into the Service Providers database 455.

The Messaging Platform database 465 is used by the Service Platform 435 for storing and retrieving subscriber messages of appropriate incoming session media, according to subscriber preferences stored in the Subscriber PPP database 450. The platform can also be used for providing the subscriber with outbound messaging services (including group distributions), not further discussed in this embodiment.

The Geographic Association database 460 provides data supporting Service Platform 435 in associating originating and terminating identifications, for example reach identifications, for example, reach numbers or reach addresses, (e.g., phone number(s) or IP Address(es) assigned to each MTAC) with approximate geographic, national, and regional boundaries with sufficient granularity for associating particular service providers with desired services. The Geographic Association database 460 contains the required associations; alternatively, the database 460 represents a service provided by one or more external entities, which may enhance or supplant the database. For example, the Geographic Association database 460 associates an IP address assigned to a subscriber's SIP device with the appropriate geographic region that is covered by one or more participating (e.g., listed in Service Providers database 455) cellular carriers or cellular-service resellers. In another example, geographic information provided by a cellular carrier (a service provider) on the approximate location of a subscriber's cellular device (obtained for example from cell-site antenna triangulation or embedded GPS circuit known in the art) is used to determine the appropriate routing of an incoming call by the Service Platform 435 based upon the rule base stored in Subscriber PPP database 450. Furthermore, when devices are collocated (e.g., when cellular phone 307 is nestled in MTAC Cradle 305), the correlation of both location data derived from these independent sources increases the reliability of geographic information and helps to reduce fraud. The Geographic Association database 460 and the AAA Subscriber Accounts database 440 are used by the Service Platform 435 to rate (i.e., establish specific price) sessions when the cost depends at least partially upon geography. The information may subsequently be used to clear payments across service providers through Payments Clearing 445.

Two or more or all of the databases 440, 445, 450, 455, 460 and 465 may be combined into a single or plural database or otherwise centralized; for example, fractions or whole parts of one or more of the databases may be located physically within the MTAC cradle 305 as a part of a front-end service platform residing in and operating under the controller of the MTAC Cradle 305, FIG. 16. One or more of the databases 440, 445, 450, 455, 460 and 465 may be divided or redundant according to various purposes known to database implementation, and the redundancies and divisions may be a part of the front-end service platform residing in and operating under the controller of the MTAC Cradle 305, FIG. 16. The databases 440, 445, 450, 455, 460 and 465 may be physically distributed and connected by networks, such as the IP network 115. In centralized control locations, Service Platform 435 may be connected to its associated databases 440, 445, 450, 455, 460, and 465 via very fast networks (e.g., high-speed Ethernet) over fast media (e.g., employing fiber-optic cable), deploying such fast server-to-database architectures as NAS (Network Attached Storage) or SAN (Storage Area Network). Service platforms and databases may contain redundant elements that are controlled to improve system availability under adverse conditions. One or more of the SIP Proxies 425, SoftSwitch & Gateways 430 and Service Platform 435 may be integrated within the MTAC cradle 305 as the proxies shown in FIG. 16.

FIGS. 5A, 5B and 5C respectively illustrate user-selectable interconnections of the MTAC Cradle 305 with cellular phone 307. FIGS. 5A and 5B represent exemplary cellular phone connections of a single embodiment, shown in FIG. 16, wherein the cradle and phone are provided with complementary plugs to be directly interconnected (FIG. 5A) or indirectly interconnected with the interposition of a cord with corresponding plug ends (the cord being removed in FIGS. 5A and 5C or being coiled within the cradle in FIG. 5A). FIG. 5C provides an alternate, cordless connection which is in use when the wired connections are sensed as not being in use. Alternatively, only one or two of the three connection methods can be deployed per MTAC Cradle 305/cellular phone 307 combination.

In FIG. 5A, the cellular phone 307 is nestled in the built-in cradle of the MTAC Cradle 305. The transmission link (for DC power, signaling and media as in FIG. 6) between the cellular phone 307 and the MTAC Cradle 305 is via a physical plug (not shown, but conventional) in FIG. 5A, or a hard-wired link connection as in FIG. 5B, or a cordless connection as in FIG. 5C. While the transmission links of FIGS. 5A, 5B and 5C may be mutually exclusive alternatives, any two of them or all three of them may be combined. For example, a single cellular phone 307 and a single MTAC Cradle 305 may each have mating plugs to directly engage as in FIG. 5A, a removable cord with complementary plug endings for direct wired connection as in FIG. 5B and a cordless connection that is activated manually or automatically when the connection of FIG. 5A or 5B is broken and presence of the cellular phone 307 is otherwise detected.

In FIG. 5B, the cellular phone 307 is operated as a corded phone. In one version, the wired connection basically extends the arrangement of FIG. 5A via a cord. The arrangement of FIG. 5B is useful when the cellular phone is used in conjunction with the MTAC Cradle 305, for example, when used in a special mode as a replacement for the Plain Telephone 103 of FIG. 3, in providing an audio or voice interface to the IP network 115. Both the corded version or the MTAC Cradle 305 of FIG. 5B and the cordless version of FIG. 5C have the capability for analog communications and analog signaling to the cellular phone. This analog mode of communication may be enabled or disabled by a manual switch provided on the cellular phone 307 or by conveying the “analog enabled” or “analog disabled” information by the MTAC Cradle 305 sensing that a plain telephone 103 is or is not connected to its plug (e.g., an RJ-11 plug) or through a cordless mechanism. The MTAC Cradle 305 that is without an RJ-11 outlet for plain telephones would signal the enabled/disabled information to the cellular phone as a constant input.

One example of the FIG. 5C cordless transmission link connection is Bluetooth, in which the Cordless Telephony Profile (CTP), issued by the Bluetooth Special Interest Group (Bluetooth SIG—a Trade Association). Bluetooth can be used to convert the cellular phone to a 100-meter-range cordless phone when needed. The CTP capability is advantageous for travelers, who then would not have to rely on the availability of an analog telephone for using the MTAC 305 in places like hotel rooms. Examples of other short-range wireless networks that can be used for the cordless connection include Ultra Wide Band (UWB), and wireless Universal Serial Bus (USB). The cordless connection of FIG. 5C most preferably remains on, i.e., powered and operative, whether the cellular phone is in the cradle as in FIG. 5A or out of the cradle as illustrated in FIGS. 5B and 5C. This is not necessary when the MTAC is provided with a cradle and a plain telephone combined in the form of a VoIP telephone with a cellular-telephone cradle. The cordless connection has the advantage of thereby removing the need for plugging in a plain telephone 103 for communicating over the IP network 115. It has a further advantage of avoiding physical interface plug mismatches, which may occur in the FIG. 5A arrangement if the cellular phone 307 did not have a plug that was compatible to the plug of the MTAC Cradle 305.

FIG. 6 illustrates the functional interfaces of direct current (DC) power, signaling and media that are provided between the MTAC Cradle 305 and the cellular phone 307. DC Power sourced from the cradle and delivered to the cellular phone enables the battery of the cellular-phone to be charged when the cellular phone is nestled in the cradle as in FIG. 5A or wire-connected as in FIG. 5B. DC power is not normally provided to the cellular phone 307 from the MTAC Cradle 305 in the case of FIG. 5C, although it could be provided cordlessly through means known in the art (e.g., inductance, photonic power . . . ). Signaling is provided both ways between the cellular phone 307 and the MTAC Cradle 305 for various control functions. Media or data transmission is provided both ways between the cellular phone 307 and the MTAC Cradle 305 for exchanging information.

In the FIG. 6 signaling interface, examples of information signaled from the cellular phone 307 to the MTAC Cradle 305 include the following: state information, such as presence; cellular service availability; on-hook or off-hook; cellular phone identification; Automatic Number Identification (ANI) of the calling party; selective content of the programmed details in the Subscriber Identification Module (SIM), which is a smart card residing in cellular phones, e.g., containing all subscriber-related data; and programming related information, including selective information relating to encryption and decryption.

In the FIG. 6 signaling interface, examples of information signaled from the MTAC Cradle 305 to the cellular phone 307 include the following: Go off-hook or Go on-hook; Probe for cellular phone identification; Accept dial string from MTAC Cradle 305; Push dial string and initiate conversation; Initiate or terminate media-stream sharing with the MTAC Cradle 305; Exchange analog media or exchange encoded digital media (optional); Add or terminate a party for multi-party conferencing; and Subscriber Identification Module (SIM) programming-process instructions.

In the FIG. 6 media interface, the media exchanged between the MTAC Cradle 305 and the cellular phone 307 may be analog and/or digital (data and/or encoded voice). For example, the media may be: digitally encoded GSM (e.g., voice) media or analog voice media, with a signaling interface, which permits a plain telephone 103 to access the cellular network via the cellular telephone 307. (GSM formerly stood for Group Special Mobile and today stands for Global System for Mobile Communication, which is a standard digital cellular phone service in many countries) Digitally encoded media require compatible codecs (coders/decoders) for sessions involving analog devices or mismatched digital devices. Gateway devices (such as MTAC Cradle 305) are used to encode and packetize analog voice and/or image and video media. Most cellular phones contain provisions for exchanging analog media, because they must interface to analog devices enabling hands-free mode use in cars.

In SIM Programming: the data listed above as examples of the “signaling” interface enables the secure programming of the SIM card residing in, for example, GSM “World Phones”. When a subscriber travels to an area that is served by a partnering cellular-service carrier, the SIM card embedded in the cellular phone 307 is replaced by one provided by the partnering carrier. In another preferred embodiment, the SIM card can be reprogrammed to operate in the geopolitical area covered by the partnering carrier. In general, a SIM Module embedded in a cell phone can be OTA (Over-The-Air) programmed by the cellular carriers that it is directly associated with. The programming of the present embodiment introduces security considerations not normally present. The SIM may need to be provisioned for operation by a cellular-service operator that has not originally provisioned the cell phone. In one such more secure preferred embodiment, the MTAC Cradle 305 is capable of programming the SIM Module embedded in cellular phone 307 when the latter is physically connected to the cradle (FIGS. 5A or 5B). In another preferred embodiment, the OTA method is followed, but only if, concurrently, the MTAC Cradle provides a SIM-unlocking signal provided by Service Platform 435. The availability of two separate communication channels (the cellular network and the IP network), improves the probability that the SIM will be programmed in the appropriate, authenticated cell phone as part of this embodiment. In another preferred embodiment the two separate channels are used to exchange complementary fractions of encryption and decryption keys. This aspect of the invention only applies to cellular devices that enable SIM-card programming. The MTAC Cradle 305 can cordlessly (FIG. 5C) transmit SIM programming information to cellular phones 307 that are capable of altering their SIM programs in response to wireless instructions.

In the FIG. 6 “DC power” interface, the MTAC Cradle 305 may preferably supply exotic power and voltage requirements as might be required for secure SIM programming; this provides another method to program the most secure portions of SIM cards, where OTA is insufficient for the required security. Thus, OTA can be used for run-of-the-mill, normal updates of the SIM card by the original provider of the Cell phone, whereas exotic power and voltage requirements may be used to program the more secure information embedded in the SIM card, e.g., the transition from one cellular carrier to another.

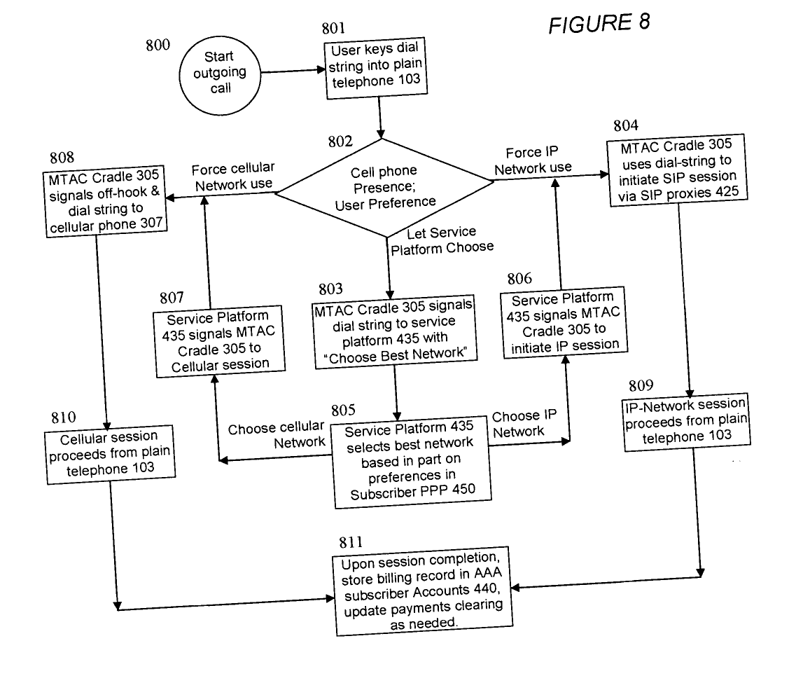

Case 1: FIG. 8 depicts an example of the process of making outgoing calls from the Subscriber Environment.

User preference (as probed in step 802) is embedded in the MTAC Cradle 305 prior to the making of an outgoing call as described herein. User preference is established through manual subscriber/user input or manual manufacturer's input; input is preferably through, for example, a keyboard, switch(es), touch pad, voice command, software (for example, a website hosted for this purpose by MTAC Cradle 305), firmware, and other hardware of the MTAC Cradle 305 during use, manufacture, and/or time of sale or lease.

The programmed process may be started in any number of conventional ways of initiating a call or started by step 801 directly. In the illustrated embodiment, the Service Platform 435, SoftSwitch & Gateways 430 and SIP Proxies 425 are built into or resident in the module of the MTAC cradle 305, but one or more or all of their functions may be separate from the MTAC cradle 305 and executed at the same or remote locations. In any event, the present invention (e.g., using the Service Platform 435) performs the example process of FIG. 8.

STEP 801: The user keys the dial string into plain telephone 103. The MTAC Cradle 305 previously received an earlier indication of user preference between: 1) forced use of a particular network; and 2) automatic program determination of network choice.

STEP 802: The MTAC Cradle 305 captures the dialed string from the Plain Telephone 103, and probes the presence and status of a connected cellular phone, and the user's manual input choice of: 1) cellular network 110, 2) IP network 115, or automatic program determination of network choice. If there is no cellular phone connected (wired or wirelessly) to the MTAC Cradle, or if the user preference calls for forcing an IP call, the process proceeds to step 804. If the user preference calls for forcing a cellular call, the process proceeds to step 808. If the user preference indicates automatic program determination of a network choice, the process proceeds to step 803.

STEP 803: The MTAC Cradle 305 signals to Service Platform 435 via IP Network 115.

The signal contains the MTAC Cradle's identity, current IP address, the string to be dialed, the presence (if any) and status of the connected cellphone, and the nature of the signal (i.e., “choose best network”). Though the Service Platform and the SIP proxies are associated with the MTAC Cradle on provisioning, the association can be reprogrammed as needed through hardware/software residing at service-provisioning centers.

STEP 805: The Service Platform 435 selects the best routes from among the Service Providers identified in database 455, for example, based upon least-cost routing (LCR). The details of the plans are stored in Subscriber PPP 450. Depending on preferences stored in Subscriber PPP 450, the conditions of the call may require that a level of expected QoS override pure LCR. The rule base of Subscriber PPP database 450 may include service-provider imposed conditions. For example, depending on the status of the subscriber's account information stored in AAA Subscriber Account database 440, the Service Platform 435 might override a subscriber's preference for higher QoS at a higher cost, thus reducing the exposure of the service provider to a non-payment risk. Cellular service contracts often include special cases (e.g., free calling among subscribers to affiliated services). The illustrated embodiment takes advantage of these special conditions by incorporating them into the rule base in Subscriber PPP database 450. Thereby, the Service Platform 435 determines the appropriate route, and signals the choice (via steps 806 or 807 below) back to MTAC Cradle 305 through the IP network 115. Service Platform 435 may choose the cellular network only if MTAC Cradle 305 had indicated the presence of cellular phone 307 as part of its best-route request.

STEP 806: When the preferred route is the IP network 115, the Service Platform 435 signals to the MTAC Cradle to initiate a session through the SIP Proxy 425 (STEP 804). Appropriate media Gateways 430 may be engaged by the SIP proxy 425 when network transition is needed, for example, from VoIP to PSTN.

STEP 804: When an IP call has been selected, the MTAC Cradle 305 used the dial-string to initiate a SIP session via SIP Proxies and control passes to STEP 809.

STEP 809: The VoIP session proceeds from Plain telephone 103, and upon termination concludes with STEP 811.

STEP 807: When the preferred route is via the cellular network 110, Service Platform 435 signals to the MTAC Cradle 305 to send the dialed string through cellular phone 307. This cellular preference may take advantage of cellular contract packages, and can only be invoked when the MTAC Cradle 305 had indicated the presence of cellular phone 307 in the cradle; this presence condition is stored in Subscriber PPP database 450, and is probed by Service Platform 435 as part of STEP 805.

STEP 808: To initiate the call via the selected cellular network, MTAC Cradle 305 signals to Cellular Phone 307 to go off hook, following by the dial string, and the SEND or CALL command (as usually depicted on a cellular phone's keypad).

STEP 810: The cellular session proceeds to its conclusion, followed by STEP 811.

STEP 811: Session completion is detected by the MTAC Cradle 305 regardless of the network type (cellular or IP) used in the session. The MTAC Cradle 305 signals Service Platform 435 that the session is complete. Platform 435 assures that the appropriate billing records are stored in AAA Subscriber Accounts 440. Either periodically or in real-time, Payments Clearing database 445 is updated to reflect services provided by participating service providers.

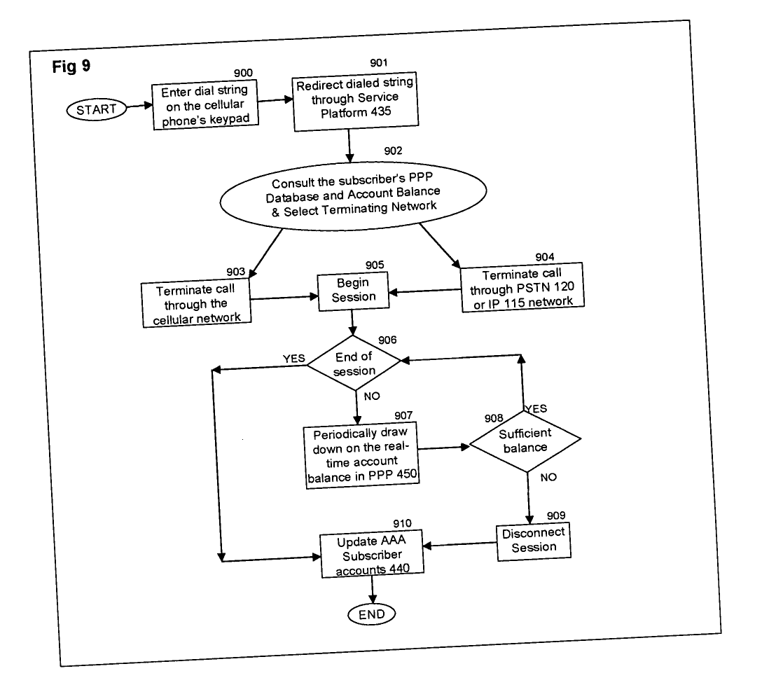

Case 2: An example of making outgoing calls, from the cellular phone 307, when it is not connected to MTAC Cradle 305 is illustrated in FIG. 9.

One feature of the present disclosure is that all subscriber calls are directed via platforms (e.g., SSG (SoftSwitch & Gateways) 430 and/or SIP Proxies 425) that are controlled by Service Platform 435.

Case 2 requires that the subscriber is appropriately provisioned so as to ensure that the subscriber's billing and service profiles reflect the association between the cellular phone, and the service.

One of the provisioning steps ensures that the cellular billing platform managed by the cellular infrastructure owner, for example, the entity that provides the underlying cellular service provided by a Mobile Virtual Network Operation (MVNO). This step ensures that the cellular billing platform updates the AAA Subscriber Accounts database 440 in real time.

Another provisioning step ensures that the Subscriber PPP database 450 reflects the specific service and association between the cellular phone and the service.

Additionally, Subscriber PPP database 450 may be designed for quick, real-time transactions, in which case it may contain operational account data from AAA Subscriber Account database 440, which may be designed for slower, non-real-time access.

STEP 900: The subscriber dials the desired number string through the cellular phone's keypad, and completes by touching the common “send” button (or equivalent).

STEP 901: All outgoing calls are signaled through the Service Platform 435. Such forcing can be done thorough: 1) agreement with the cellular carrier for redirecting all calls through the service platform 435; or 2) by ensuring that the cellular phone 307 always dials out such non-standard calls through the service platform 435, for example by using explicit user-triggered double-dialing. Alternatively, implicit double-dialing can be accomplished through cellular phone programming, since the dial string leading to the Service Platform 435 can be fixed. The process continues to Step 902.

STEP 902: The outgoing call is routed by the Service Platform 435 in accordance with the rules of Subscriber PPP database 450 and the balance associated with the subscriber's account. In addition to balance and preferences, routing depends on the nature of the called session and its destination. When the Service Platform 435 selects terminating the call through the cellular network, the process continues in Step 903. When the Service Platform 435 selects terminating the call through an alternative (PSTN 120 or IP 115) network, the process continues in Step 904. In general, barring preferential conflicts, flat-rate cellular calls are redirected through the cellular network 110. If the call is addressed to a premium-priced number (“premium” is relatively defined in comparison to the subscriber's cellular service agreement), the process proceeds to Step 904. Though the disclosure differentiates between an originating cellular network and other types of terminating networks, the present invention includes cases in which the terminating network is a cellular network that is operated separately from the originating cellular network.

STEP 903: Routes call termination through the originating cellular network. The session begins in STEP 905, and the process continues with STEP 906.

STEP 904: In this step, the Service Platform 435 routes the premium-priced call through inexpensive routes. For example, VoIP communication service can be used to route VoIP packets to the called number via a gateway residing in a location from which PSTN (or cellular service, if the called number is a cellular phone) is inexpensive. Such a location is usually the country in which the called party resides. Sometimes the inexpensive route is provided through the PSTN, especially when the quality dictated in the subscriber's PPP cannot be provided by VoIP. The session begins in STEP 905 and the process continues in STEP 906. As discussed in Step 902, STEP 904 may terminate calls through a cellular network other than that originating the call.

STEP 906: When the session ends, the process continues in Step 910. While the session continues, the process continues in Step 907.

STEP 907 draws down on the subscriber's account balance as the session continues, and STEP 908 probes the sufficiency of that balance for continuing the session. If the balance is sufficient, the process returns to Step 906. If the balance is insufficient, Step 909 terminates the session, and the process continues in Step 910.

STEP 910: At the end of the call session, Service Platform 435 updates the billing record associated with the subscriber in AAA Subscriber Accounts database 440. This may be necessary because the instantaneously available balance is maintained in a real-time database in subscriber PPP 450. Service Platform 435 updates the Inter-service-provider clearing payment records as needed (periodically or in real-time) in the Payments Clearing database 445. Once the databases are updated, the process ends.

Case 3: Incoming calls to the subscriber's one number. In a conventional one number system, the caller calls a person using a single number, and a computer system dials a plurality of possible numbers serially, in parallel, according to the called subscriber's preferences, and/or according to the caller's responses to prompts, in an effort to locate the party being called. The party being called may be at or using a different device at different locations.

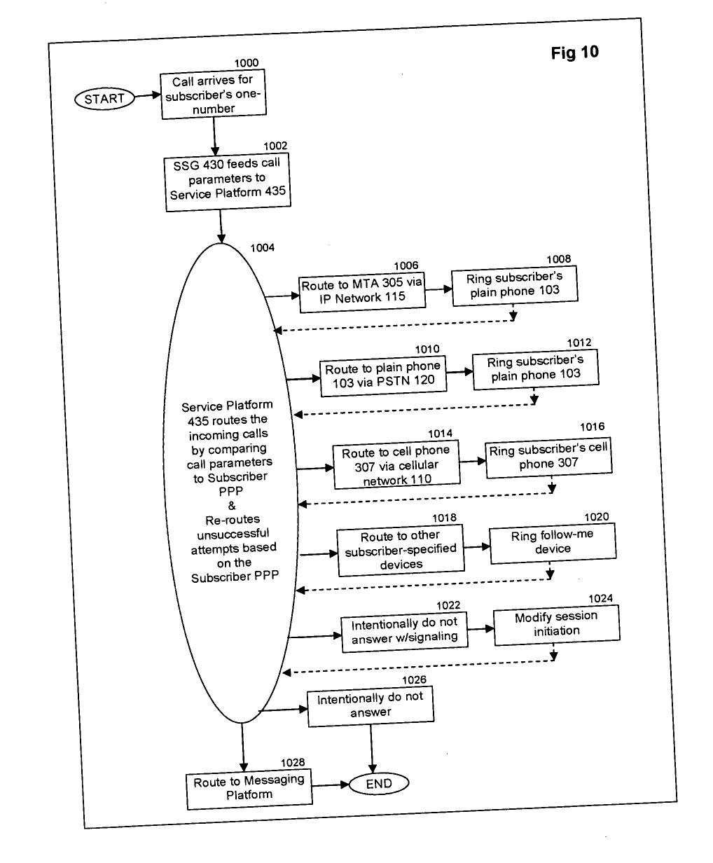

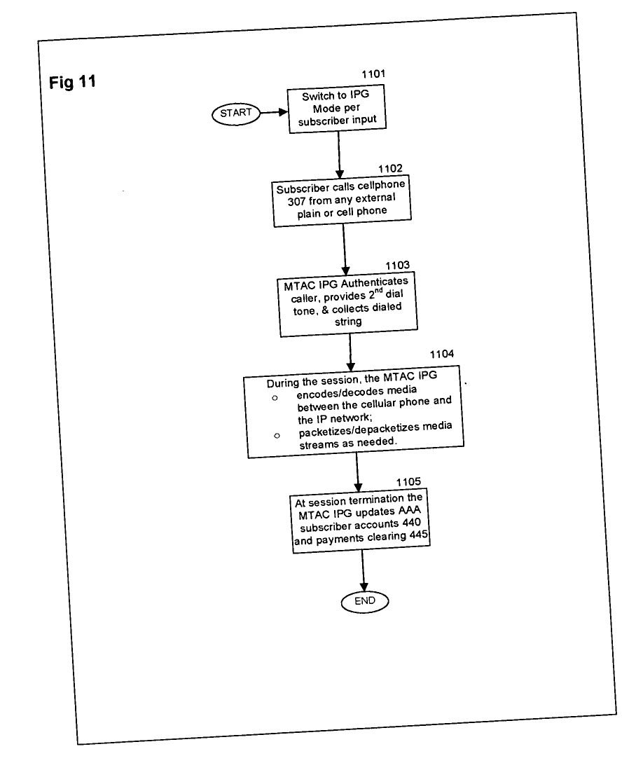

FIG. 10 is a flow diagram of the exemplary embodiment service for incoming calls to the subscriber's “one number”.

STEP 1000: When an incoming session is addressed to the subscriber's one number, the incoming call is directed to the Service Platform 435 via SSG 430. This can be accomplished by registering the subscriber's one number with the operator of the subject of this disclosure, e.g., as a “responsible organization” for local-number portability.

STEP 1002: SSG 430 feeds relevant (e.g., those used in Subscriber PPP to treat the call in prescribed ways) call parameters to Service Platform 435. The subscriber's preferences, rules and presence information, as stored in Subscriber PPP database 450 are preferably used in the processing, particularly to determine if the call is required to be redirected.

STEP 1004: Service platform 435 compares the call parameters (e.g., the originating device, network and/or person, the time of the call) to the rule base implied by Subscriber PPP 450, and treats the accordingly. STEPS 1006, 1010, 1014, 1018, 1022, 1026, and 1028 are examples of possible call treatments. STEP 1004 also redirects failed call attempts according to the subscriber PPP 450, based on the newly established conditions of failures. As dictated by preferences stored in the Subscriber PPP database 450, the Service Platform 435 may redirect the call.

STEP 1006: In a possible PPP-default (or PPP-prescribed) circumstance the incoming call is routed by the Service Platform 435 to terminate at MTAC Cradle 305 via IP Network 115. If the incoming call is a PSTN Plain telephone call, this routing involves the insertion of a media gateway by SSG 430. The process proceeds in STEP 1008.

STEP 1008: The subscriber's plain telephone 103 is rung through MTAC 305. If the phone is answered, the session proceeds in the usual manner to its conclusion, and the Service Platform 435 updates AAA Subscriber Accounts. The latter action is independent of subscriber-account draw down (which may not be relevant for incoming calls), but is necessary to record the duration of sessions for which ultimate payments clearing with other service providers may be necessary (e.g., for charging a call termination fee to the originating-call carrier). If the call is not answered after a prescribed duration, control of the call returns to Service Platform 435 for further treatment based on the new condition of “no answer”.

STEP 1010: When plain telephone 103 is (also) directly connected to PSTN 120, then Service Platform 435, after consulting with Subscriber PPP 450, may route the incoming call via the PSTN 120. The process proceeds in STEP 1012.

STEP 1012: Plain telephone 103 rings; if the phone is answered, the session proceeds in the usual manner to its conclusion, and the Service Platform 435 updates AAA Subscriber Accounts. If the call is not answered after a prescribed duration, control of the call returns to Service Platform 435 for further treatment based on the new condition of “no answer”.

STEP 1014: Service Platform 435 routes the call to cell phone 307 via cellular network 110. The subscriber's cell phone 307 is rung through the cellular network 110. The process proceeds in STEP 1016. In a preferred embodiment, the routing logic associated with Service Platform 1004 takes into account the carrier that issued the originating phone number, since certain cellular calling plans provide free airtime among plan participants, and the subscriber may gain from accepting he call over the cellular network; it is therefore advantageous if the “one number” is the subscriber's cellular phone number.

STEP 1016: If the cell phone 307 is connected to MTAC Cradle 305, the subscriber has a choice of responding by picking up Plain Telephone 103 or by going “off hook” on cellular phone 307. If the subscriber is away from the Subscriber Environment 300, the session is picked up via cell phone 307. If the call is answered, the session proceeds in the usual manner to its conclusion, and the Service Platform 435 updates AAA Subscriber Accounts. If the call is not answered after a prescribed duration, control of the call returns to Service Platform 435 for further treatment based on the new condition of “no answer”.

STEP 1018: When dictated by preferences stored in the Subscriber PPP database 450, the Service Platform 435 redirects the call to a different destination, e.g., as is common in “follow-me” type services. The process proceeds in STEP 1020.

STEP 1020: The follow-me device rings. If the call is answered, the session proceeds in the usual manner to its conclusion, and the Service Platform 435 updates AAA Subscriber Accounts. If the call is not answered after a prescribed duration, control of the call returns to Service Platform 435 for further treatment based on the new condition of “no answer. This may sometimes include a sequence of other follow-me devices.

STEP 1022: Service Platform 435 encounters a condition requiring a modification to the incoming session initiation attempt. For example, the call-initiation may be from a cellphone number that is listed in subscriber PPP 450 as preferring the use of the originally assigned cellular phone number (rather than the subscriber's one-number). This may desirable when the subscribed cellular service package includes unlimited free calling among some group of subscribers. Then the process proceeds in STEP 1024.

STEP 1024: Service Platform 435 informs (e.g., via text or voice message) the caller through the calling device (e.g., cellphone) of the need to restart the session initiation attempt in a different manner. Two preferred embodiments include (i) establishing a callback from cellphone 307 to the calling number; and (ii) signaling to the calling device the phone number to be used by the caller in a follow-up session-initiation attempt, and terminating present the incoming session-initiation attempt.

When embodiment (i) is used, and cellular phone 307 is connected to MTAC Cradle 305, the following details one embodiment for generating the call-back. Service Platform 435 sends a message to the MTAC Cradle 305 over the IP Network 115, which message includes “call the number provided herein through the (connected) cellular phone”. The MTAC Cradle 305, causes cellular phone 307 to go off hook and dial the caller's number while the MTAC Cradle 305 rings plain telephone 103. Those skilled in the art can transform the method for integrated MTAC Cradle 305/telephone devices. The Subscriber picks up plain telephone 103 or takes the cell phone 307 off the cradle of MTAC Cradle 305 and listens to the ringing of the phone of the original caller. The subscriber then begins the session when the original caller responds.

When embodiment (ii) is used, the following details one embodiment for initiating a new, modified session to the subscriber (by the caller). While the calling cellular phone continues its connection attempt, the Service Platform 435 sends an alphanumeric or Short Message Service (SMS) message to the caller with the number of the cellular phone 307. In one aspect of this embodiment, the calling cellular phone terminates the calling attempt and initiates a separate call to the cellular phone 307. Alternatively, the phone number of cellular phone 307 is hidden from the user of the calling cellular phone, and the entire hang-up-redial transaction occurs under the control of a program residing in the caller's cell-phone.

STEP 1026: Service Platform 435 ignores the incoming call attempt by not alerting any subscriber device that the call is being attempted. This is a distinct option from STEP 1028.

STEP 1028: When dictated by preferences stored in the Subscriber PPP database 450, the Service Platform 435 redirects the call to the Messaging Platform 465, which permits the caller's message to be recorded for subsequent subscriber access. Messaging Platform 465 may be a part of the Service Platform 435 or separate from it as shown in FIG. 4.

Case 4: International Use.

One of the features of the MTAC Cradle 305 is its portability. When a VoIP MTA is plugged into an appropriate IP network anywhere around the world, it registers its new IP address with the service provider's registrar (e.g., a SIP registrar) and call redirectors (e.g., SIP Proxies) ensure that incoming calls to the subscriber's address (e.g., SIP Address) follow the subscriber via the IP network. When the MTAC Cradle 305 is moved to a different geographic area and plugged into an appropriate network there, the geographical presence is recorded in the Subscriber PPP database 450 as a result of the original handshake that enables the MTAC to register as “available for service”. The set of rules applying in international situations are different, especially because of differences in session transport costs and in the cellular environments.

The subscriber's service provider establishes relationships with other service providers around the world. These relationships enable global coverage and uniformity in service behavior from the viewpoint of the subscriber, and establish geographic associations between the subscriber's location, the relevant service providers and the relevant preferences/rule-base applying when operating from that environment.

Nationally and internationally, local service providers with whom agreements are desired include broadband access providers and cellular carriers or resellers. Business agreements may be formed bilaterally or through a centralized service Federation or Clearinghouse (covered in Case 5 below). The business agreements are the source of much of the data that populates the Service Providers database 455, the Payments Clearing database 445, and the Geographic Association database 460. Service-provider provisioning & de-provisioning processes include system security and financial safeguards known in the art. For example, authenticated services administrators and systems with specific roles are permitted to populate and/or modify specific portions of the databases 440, 445, 455 and 460, whereas other service participants and systems are merely allowed to read portions of the data. Subscribers to the service obtain secure authentication means upon service provisioning for permitting access to corresponding portions of the Subscriber PPP database 450 to populate and alter their profile and preferences data. The systems protect against other access, data contamination, or denial-of-service attacks by known means that are outside the scope of this invention.

The term carrier is used interchangeably with cellular service provider, cellular service reseller, Mobile Virtual Network Operator, or others who provide the same relevant services.

The cellular phone 307 that is used by a subscriber who travels abroad may be the same cellular phone 307 the subscriber uses in the home country if the cellular phone enables international use. For example, a model that currently enables international use is the GSM World Phone that enables international use through participating cellular carriers as long as the SIM card embedded in the cellular phone is preprogrammed, replaced or reprogrammed to operate in the region of travel.

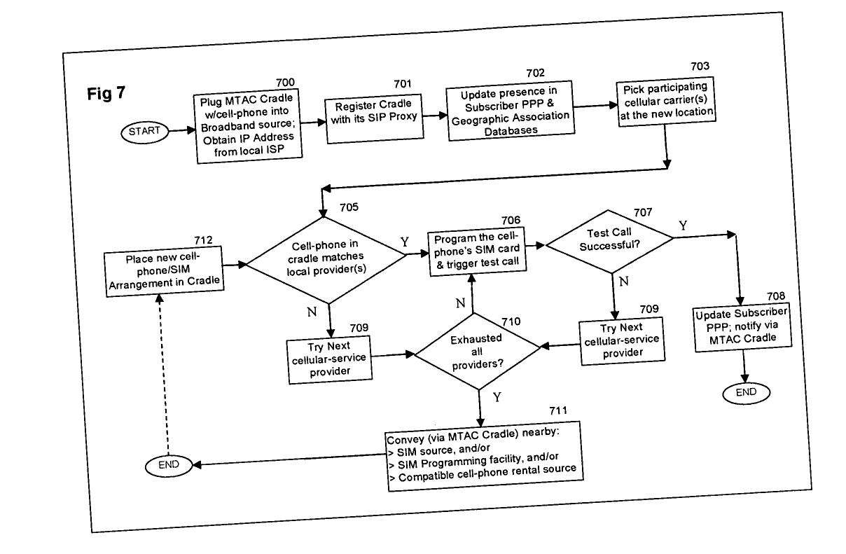

FIG. 7 describes an exemplary MTAC Cradle 305 and Cellular-phone 307 international registration process that extends the service internationally.

STEP 700: When an MTAC Cradle 305 with a connected cellular phone 307 is plugged into an outlet of a broadband network, such as the IP Network 115 of FIG. 3, or otherwise establishes signaling and data connection with the IP Network 115, the MTAC Cradle 305 obtains an IP address from a local Internet Service Provider (ISP). The broadband ISP may be participating as a service provider of Service Providers database 455 or non-participating, for example as obtained by the subscriber aboard.

When a VoIP MTA is plugged into an appropriate IP network anywhere around the world, it registers its new IP address with the service provider's registrar (e.g., a SIP registrar) and call redirectors (e.g., SIP Proxies) ensure that incoming calls to the subscriber's address (e.g., SIP Address or PSTN phone number) follow the subscriber via the IP network.

STEP 701: The MTAC Cradle 305 provides information to be registered with its SIP Proxy 425. That is, there is a registration of the MTAC Cradle 305 with its SIP Proxy 425. This registration follows known and evolving SIP and follow-on standards.

STEP 702: The Service Platform 435 is alerted to record changes in the presence of the MTAC Cradle 305 in the Subscriber PPP database 450; that is, the new geographical presence is recorded in the Subscriber PPP database 450 as a result of the original handshake that enables the MTAC Cradle 305 to register as “available for service”. The geopolitical region in which the MTAC Cradle 305 resides is established through an association of the IP address assigned to the Cradle with its expected geography. The Service Platform 435 uses the Geographic Association database 460 to adjust geography dependent presence conditions in the Subscriber PPP database 450 to reflect the new geographic location of the MTAC Cradle 305, so that the appropriate set or sets of rules may be applied to the new geographic location.

When service providers are registered to provide internet services described in this disclosure, appropriate entries are made to Service Providers 455, and to the Geographic Association database 460 by service administrators and participating service providers. This enables subsequent association between subscriber location and the service provider(s) with whom an agreement to supply a subscribed service in that geographic area exists. For example, a participating provider of Cellular Network 110, which tracks the location of and communicates with cellular phone 307, defines an approximate geographic location at the required degrees of granularity, the identity of the service provider usually provides at least a national geographic boundary within which the cellular phone 307 is present. The identity of the cell-site or cell sector in communication with the cellular phone 307 further refines the geographic location of the cellular phone 307 as needed. Other cellular phone location techniques (e.g., triangulation among multiple cell sites) permit the cellular carrier to improve the precision of the location of the cellular phone 307. A very precise location could be establish for cellular phones 307 that incorporate GPS receivers. The GPS receivers have the following additional advantages: (i) precise location can be established independently of the cellular carrier, and (ii) this precision may be sufficient to forego the need for placing the cellular phone 307 in MTAC Cradle 305 for the subset of the services that rely on the collocation (but not necessarily the connection) of the MTAC Cradle 305 and Cellular phone 307.

STEP 703: The Service Platform 435 then associates the Service Providers database 455 with the derived geography in the Geographic Association database 460 from step 702, to pick one or more participating cellular carriers active at the new geographic location listed in “presence” in the Subscriber PPP database 450 as updated in step 702.

STEP 704: After the MTAC Cradle 305 identifies the cellular phone 307 connected to the MTAC Cradle 305, the MTAC Cradle 305 sends through the IP network 115 to Service Platform 435 the identity and capabilities of the cellular phone 307. Alternatively, the unique number associated with the cell phone may be transmitted through the MTAC cradle, followed by the Service Platform or its agent performing equipment lookup in an authorized-cellphone database (not shown in FIG. 4) established and maintained for the purpose of this service. In the trivial case, the cellular phone is the one used by the subscriber at the home-base, and its capabilities are known. International standards such as IMEI (International Mobile Equipment Identity) define the aforementioned unique number.

STEP 705: The Service Platform 435 determines if the type of cellular phone 307 is compatible with a local cellular carrier registered in database 455 for that geographic region.

When subscribers use internationally capable cell-phones such as the GSM World phone, it is possible to adapt the subscriber's original cellular phone to local conditions by modifying the SIM card or installing a new SIM card available from local cellular carriers around the world.

STEP 706: When there is a match in step 705, the Service Platform 435 begins a process designed to program the SIM card of the cellular phone 307 to match local conditions, followed by a test cellular call to/from the connected cellular phone 307 to some test number. The process of programming the SIM card includes three alternative embodiments; (i) obtaining a substitute SIM card from a local participating cellular service provider and inserting it in the cellphone 307; (ii) using the Service Platform 435 to program the SIM card (via IP Network 115) that is within the cellphone connected to the MTAC cradle 305; (iii) giving a local participating cellular service provider access (via IP network 115) to the MTAC cradle 305 for the purpose of programming the SIM card that is within the cellphone connected to it. Alternate embodiments (ii) and (iii) require the inclusion of SIM-programming features. For example, the MTAC Cradle Plus (“Plus” designation refers to the SIM-programming capabilities) will enable the programming of the SIM card to occur in a manner similar to that used by SIM card programming devices today. Since SIM-card programming must be performed under secure conditions to avoid spoofing and fraud, the MTAC Cradle Plus is ideally suited, being able to provide two separate, coordinated, potentially encrypted communications channels (cellular and IP) to the same cellphone 307 device. The illustrated embodiment covers the programming of the SIM card when it is installed in cellphone 307, or when it is removed from the phone and placed in a special slot-connector that may be optionally provided for this purpose in the MTAC Cradle Plus.

STEP 707: When the test call is successful, as confirmed by the MTAC Cradle 305, the Service Platform 435, the process proceeds to step 708. When the test call fails, the process proceeds to step 709.

STEP 708: The Service Platform 435 will enter the new cellular phone number into the Subscriber PPP database 450 and inform the subscriber via the MTAC Cradle 305, the cellular phone, or a text message (e.g., SMS). Exemplary notifications include: (i) the inclusion of a small display device on the MTAC Cradle 305 (or using the cradle/SIP Phone display if the MTA is integrated), (ii) the use of the cell-phone's display to convey such messages, or (iii) through voice messages called into the plain phone connected to the MTAC Cradle 305. The Service Platform 435 also updates other platforms and databases to ensure the continued smooth operation of the disclosed service from the new location.

STEP 709: If the SIM programming is unsuccessful for a specific cellular service provider or carrier serving that area, the next such cellular service provider (matching the general characteristic of the cellular phone that sits in the cradle, as was determined in step 704) will be attempted after STEP 710 is performed.

STEP 710: The Service Platform 435 determines if a next cellular service provider was obtained in step 709 and if so, processing returns to step 706; if no next cellular service provider was obtained in step 709, then all potential providers have been exhausted, and processing moves to step 711.

STEP 711: Once all available compatible local cellular carriers are exhausted, the Service Platform identifies alternative methods for obtaining a compatible cellular service, and conveys the information to the subscriber via the MTAC Cradle 305. The geographic association 460 correlates the locations of facilities that are nearest to the subscriber for inclusion in the message. The process ends here, until appropriate action is taken by the subscriber based on the information provided herein. The Service Platform 435 assumes that the subscriber has no compatible local cellular phone until a new one is found and tested as described in STEP 712.

STEP 712: If/when the subscriber obtains a compatible SIM card or a new (usually rented) cell-phone, the process resumes in step 705.

To get to STEP 712, the subscriber obtains service that is covered under the original subscriber agreement as described in Subscriber PPP database 450 and AAA Subscriber Accounts database 440. However, it is possible that the subscriber obtains a new cellphone and/or cellular services from a non-participating service provider. In that case, the newly recruited local cellular carrier provides Service Platform 435 with all the required data so that the appropriate databases 440, 445, 450, 455 and 460 can be populated and/or updated.

Case 4A: Portability and International Use.

The MTAC IP cradle can be used as a personal gateway when the cellular phone 305 is connected to cradle 305. The term “connected” (as used throughout this specification) includes not only the literal meaning of “in the cradle” or “nestled” as in FIG. 5A, but also that the cellular phone 307 is operatively in the vicinity of the MTAC or MTAC IP Cradle 305 for direct communication as in FIG. 5B and FIG. 5C.

In many cases, moving the MTAC Cradle 305 within US boundaries keeps it within the cellular service provider's network. Depending on the cellular service agreement, service at remote locations may be provided through roaming agreements, which sometimes are priced at a premium. These details are pre-provisioned in the Service Providers database 455 by service administrators. Normally, the linking of the locally-assigned IP address with the Geographic Association database 460 enables the service provider to select the appropriate charging plan for the use of the local cellular network 10. In another aspect of this invention, the state of connectivity (e.g., “digital”, “analog roaming”) of cell phone 307 is provided to the Service Platform 435, preferably through the MTAC Cradle 305 via the interface with the cradled cell phone 307; this enables the Service Platform 435 to determine the true cost of each call based on local, real-time conditions. The state of connectivity is not constant; for example, it may be dependent upon instantaneous cellular-network load.

In areas where the subscriber's cellular phone 307 operates, the cellular network 110 used to access the cellular phone 307 can provide additional geographic information that can be used to verify the location provided through IP-address association. The Geographic Association database 460 cross references the association between the subscriber location based on the cellular service provider and the subscriber location provided based on the IP address, and confirms that an agreement to supply a subscribed services in that geographic area exists. As discussed above with respect to STEP 702, the location of the cellular phone 307 can be tracked to an approximate geographic location to whatever degree of granularity is required.

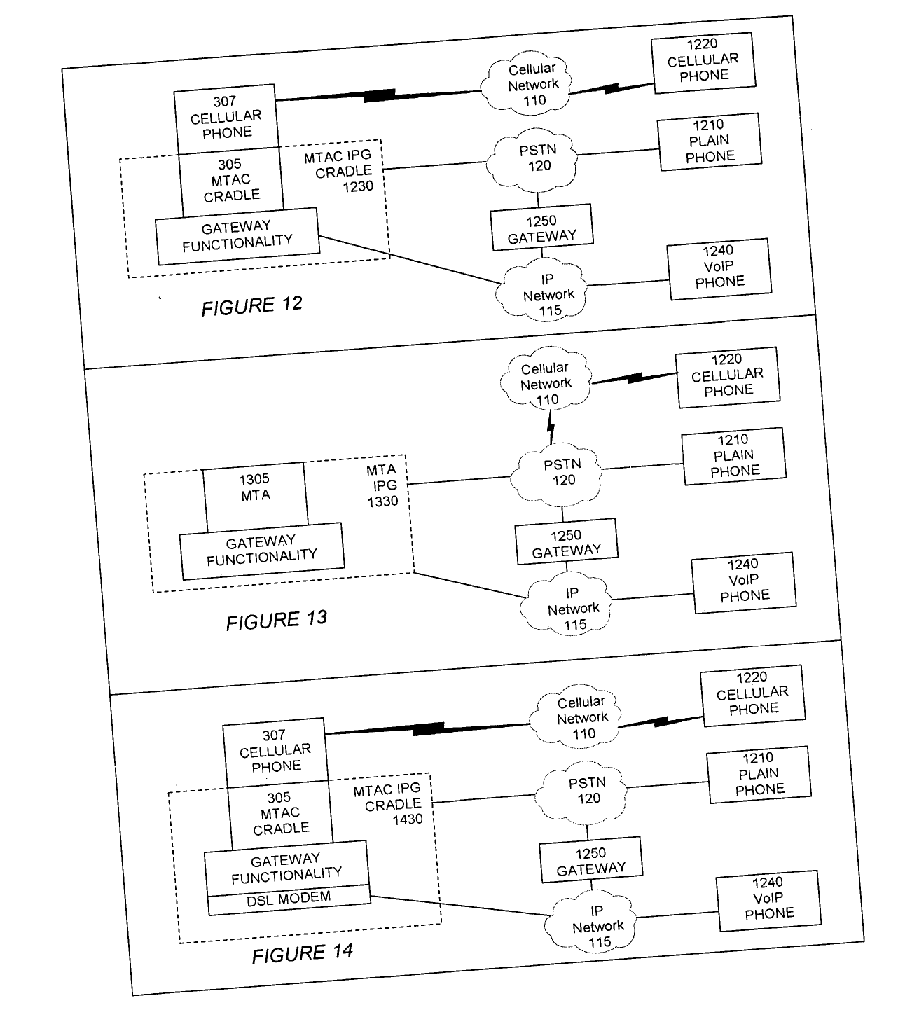

Case 5: The MTAC Cradle 305 is adapted to be a gateway between the Cellular Network 110 (and optionally the PSTN network if connected thereto) and the IP Network 115; when adapted in this manner, the cradle becomes an MTAC IPG (MTA Cellular IP Gateway) 1230. The MTAC IPG Cradle 1230 of FIG. 12 is a personal, multimedia IP communications (e.g., VoIP) portable gateway, which can accompany the subscriber abroad and operate abroad or domestically according to the example process disclosed in the flowchart of FIG. 11. The MTAC IPG Cradle 1230 can be connected to and support incoming and outgoing communications from the cellular or PSTN networks, so that the subscriber can use any local phone (plain phone 1210 or cellular phone 1220) to communicate via the IP network 115 (e.g., using VoIP). Optionally, the MTAC IPG 1230 may also be connected to the PSTN, providing a gateway capability between any two of the three networks.

FIG. 13 (discussed later) illustrates a known MTA IPG. An MTA IPG is equivalent to the MTAC IPG that does not include the functions of the cellular cradle or connectivity. A personal gateway accepts incoming calls for the purpose of routing them through a different network to the ultimate destination. To be a personal gateway, the MTA or MTAC Cradle includes gateway functionality, such as, the ability to collect a string of DTMF tones dialed after providing a dial tone to the calling phone, and perhaps a voice-response capability for ease-of-use and for security/caller authentication purposes.

The traveling subscriber sets up the MTAC IPG in the same manner described for the MTAC in Case 4. More particularly, with respect to FIG. 7, after broadband connection and obtaining an IP address, step 700, the MTAC IPG is registered with the SIP Proxy 425 and the Service Platform 435 as before, (step 701), and the MTAC IPG presence is recorded in Subscriber PPP database 450 with the appropriate geographic association in the Geographic Association database 460, step 702. The processing of the remaining steps of FIG. 7 is performed to reach step 708 where the cellular phone 307 is now operable with a local cellular service provider.

In order to use the MTAC IPG 1230, the (e.g., internationally) traveling subscriber leaves the cellular phone connected to the cradle, in order to communicate internationally using any local phone. In one preferred embodiment, the subscriber uses a local phone (landline or cellular) to call the MTAC IPG-connected cellular phone, then communicates internationally over VoIP via the private gateway. The term “local” refers to call cost in that a local call is any call that would make the cost of calling the MTAC IPG viable.

FIG. 11 describes an example of the use of the MTAC IPG 1230 once the cell-phone is operational.

STEP 1101: To differentiate between using the MTAC Cradle 305 in a normal mode or in a gateway mode (MTAC IPG Cradle 1230), the subscriber switches manually, or alternatively, the mode change is triggered by the subscriber usage (e.g., through DTMF signaling), after the cellular phone goes off-hook while connected to the MTAC IPG Cradle 1230.

STEP 1102: The subscriber uses plain phone 1210 of FIG. 12 to dial the number of the locally active cellular phone 307 (a first dial string), which is connected to the MTAC IPG Cradle 1230. The call passes locally through the PSTN 120 and Cellular Network 110 and is transmitted to the cellular phone 307. Alternatively, the subscriber uses cellular phone 1220 to dial cellular phone 307 in order to access the MTAC IPG 1230.

STEP 1103: The MTAC IPG Cradle 1230 senses the incoming call to the cellular phone 307 by the signaling of FIG. 6, and the MTAC IPG Cradle 1230 causes the cellular phone307 to go off hook; voice prompting or other automatic communication is provided for a better subscriber experience and to involve the subscriber if desired.

STEP 1104: The MTAC IPG Cradle 1230 authenticates the caller, and provides a 2^{nd} dial tone. The caller (the subscriber or any person he authorizes) dials out to reach the desired party over the IP Network 115 through the MTAC IPG 1230. The desired party may be for example at the VoIP phone 1240 in FIG. 12 that is located in another country, or at a plain telephone that is connected via a VoIP service provider's gateway 1250. The signaling of FIG. 6 may be used when the subscriber dials the second number. It the preferred embodiment, the ANI of the calling phone is used at least as part of the authentication process. In this manner, the subscriber may use the MTAC IPG 1230 with a minimum of added effort.

STEP 1105: The cellular phone is constructed to enable direct media flows with the cradle, in addition to signaling, as shown in FIG. 6. The media flows may be voice as spoken into or received by the cellular phone 307, and video, stills, or graphics as permitted by the cellular phone 307. Media flow occurs through physical connections in the cradle or through short-range networks like Bluetooth, UWB or Infrared as in FIGS. 5A, 5B, 5C. These media flows are already encoded/decoded by the cellular codec that is in the cellular phone 307.

When, the cellular codec is also used in the IP Network 115, then the MTAC IPG does not transcode the media stream between the cellular phone 307 and the MTAC IPG 305, removing a significant source of QoS degradation. In that case, the MTAC IPG 305 still performs media packetizing depacketing and buffering, which are standard functions of media gateways.

When cellular CODECs become a standard part of VoIP options deployed at all VoIP phones and media gateways, then the cost of the MTAC IPG Cradle 305 is reduced.

STEP 1106: At the end of the session, the MTAC IPG 1230 in cooperation with the Service Platform 435 update AAA subscriber database 440. The subsequent transaction against the Payments Clearing database 445 may be executed in real time or in periodic batch runs.

The “local” call the subscriber makes to the MTAC IPG Cradle 1230 is preferably charged to the subscriber through local arrangements. As an option, most of such costs are registered in the AAA Subscriber Accounts database 440 by, for example: (i) including the local service carrier among the Service Providers in 455, with pre-established billing arrangements, for example, the local call can look like a prepaid-card call, (ii) renting a separate cellular phone 307 from a participating service provider for this purpose, or (iii) combining the second arrangement (ii) with establishing the local call as a reverse-call through the use of such alerting techniques as text messaging in the cellular phone 307.

As shown in FIG. 13, an MTA IPG (i.e., one without a Cellular Cradle) 1330 includes two network connections, one to the broadband IP network 115, and the other to the PSTN network 120. The MTA IPG requires a standard array of Codecs. The MTA IPG operation is similar to that described for the MTAC Cradle IPG 1230, except that the incoming “local” call comes in from the PSTN for the MTA IPG and not from a cellular network as described for the MTAC Cradle IPG 305. Cellular phone 1220 and Plain Phone 1210 are used by the subscriber to make or receive calls via the MTA IPG 1330 in the local (e.g., foreign) environment. These phones and VoIP Phone 1240 also represent initiating and terminating devices for calls to/from the subscriber. Gateway 1250 may be one of SSG 430 gateways.

Large scale deployment of a MTA IPG constitutes a traditional VoIP gateway (such as 1250). The providers of such services may be included as Service Providers in database 455, enabling subscribers to forego the use of personal gateways in certain geographical areas. Accounting, clearing and subscriber billing relative to traditional VoIP gateways may be integrated with the accounting, clearing and subscriber billing using the databases 440, 445, 455 and 460 of FIG. 4.

Where traditional VoIP gateways are used for subscribers of this disclosure, those versed in the art can appreciate the ability to route incoming calls to the traveling subscribers' POTS or cellular phone numbers registered in the Subscriber PPP database 450.

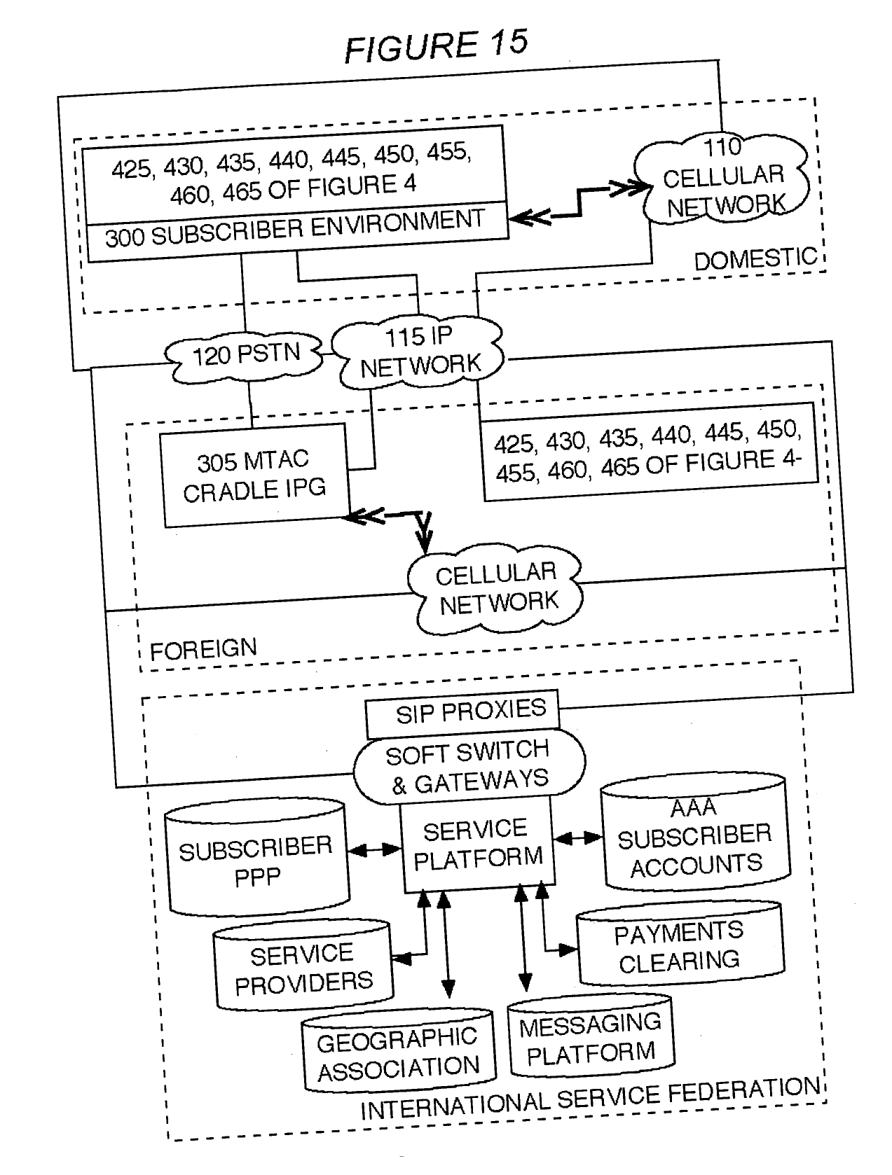

In addition to all of the structure, functionality and operation of the MTAC IPG Cradle 1230 described herein, the MTAC IPG Cradle additionally includes, as a further enhancement, a built-in DSL modem, as shown in FIG. 14. The DSL modem enables the MTAC IPG Cradle 1430 to be plugged into a single network connection, conveying both PSTN traffic and broadband traffic over the same DSL transmission link connector. In that case, the MTAC IPG 1430 may include connectivity to PSTN 120, IP Network 115, and Cellular Network 110.

Case 6: International Service Federation.

The service of the present disclosure involves multiple service providers. The providers may be geographically exclusive or geographically competitive. The preservation of quality standards dictates the need for a single quality-control entity that filters potential service providers by quality of service and financial strength. The service providers may form a federation that co-manages the service of this disclosure.

Such federation arrangement may include self-provisioning capabilities that are supervised through the use of mandatory approval-role workflow arrangements. Provisioning will at least partially populate a plurality of databases: the Subscriber PPP database 440 having information specific to subscribers of the one number services, the Service Providers database 455 having details of service providers participating in integrated one number services available to the subscribers, the Payments Clearing database 445 specific accounting information and service pricing according to the legal agreement between the service provider and the federation, and the Geographic Association database 460 slotting the new provider to particular service-geography pairs.

As discussed earlier in this disclosure, private subscriber arrangements with service providers constitute a significant potential marketing force for the federation, since the registration of the subscriber's e.g., cellular phone and service in new geography may trigger the registration of the new service provider in the federation.

The International Service Federation coordinates the services and related accounting of a plurality of multinational service providers that offer one number services for communication over one or more of IP, PSTN and cellular networks for satisfying subscriber communication needs.

QoS Improvement

Where a cellular call is conventionally routed via an IP Network, a significant degradation of the quality of service (QoS) normally ensues due to the use of at least two media gateway operations. In one media-gateway operation, the cell phone 307 compresses voice into a format suitable for the cellular medium, for example by using GSM or Code Division Multiple Access (CDMA) codecs. A codec is a coder/decoder, which is usually found as an element of a gateway, MTA, VoIP phone, or software program that compresses and decompresses media, for example voice or video media. Video or still picture formats are used in some cellular phones. In the second media-gateway operation, a VoIP gateway that is a part of Gateways 430 transcodes the media to a format suitable for transmission over an IP network. Transcoding modifies the stream of data so that it may be carried via a different type of network and by way of example may involve one of the series of suggested standards covering transmission facilities in different networks, namely standards G.711, G.713.1 and G.729A, which are ITU-T standard voice Codecs.

To avoid unnecessary degradation in QoS, cellular codecs may be used at gateways of the IP network during call session initiation. For example, the Service Platform 435 uses one of the SIP Proxies 425 to force (via SIP signaling) a match between the cellular telephone's 307 codec and the codec used at the gateway to the IP network 115. Thereby, transcoding is avoided from the cradled cellular phone 307 to the IP network 115. There is still a need for packetizing and/or depacketizing at transition points between networks, but adding or selecting of a codec at session initiation according to the illustrated embodiment eliminates the need for some or all transcoding. Therefore, the QoS of cellular voice traversing IP networks increases commensurately with the elimination of transcoding. This matching of Codecs simplifies the design of the MTAC cradle 305, since the MTAC cradle 305 needs to operate as a gateway to the IP Network 115, and/or as a gateway between the plain telephone 103 to the cellular phone 307.

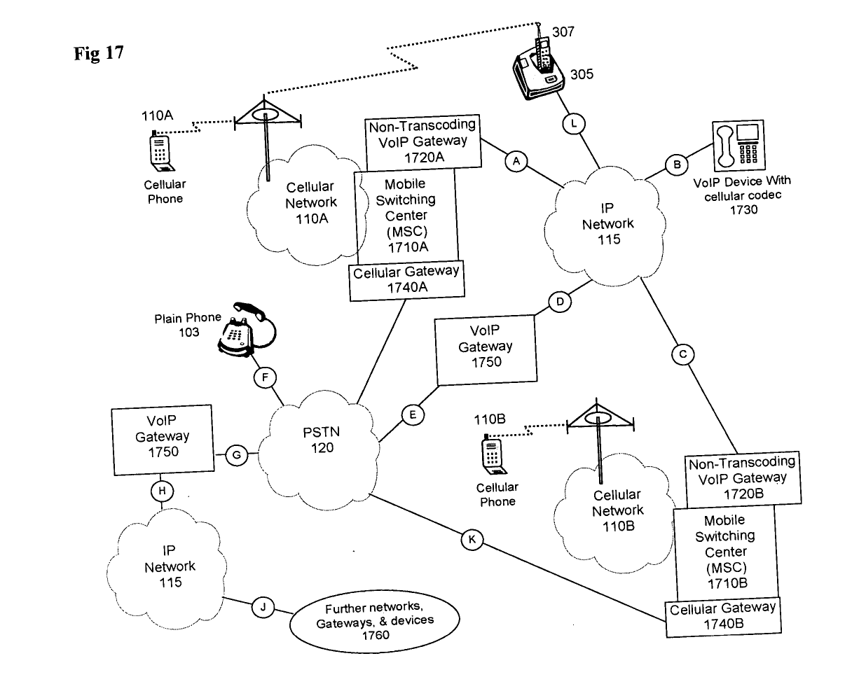

FIG. 17 provides additional details of such QoS improvements. FIG. 17 illustrates the elimination of QoS-reducing transcoding stages that occurs when IP codecs (e.g., VoIP codecs) are identical to cellular codecs. This requires cellular codecs to be among those present in transcoding gateways, VoIP phones 1730, and other digital devices such as computers running VoIP programs.

Non-transcoding gateways 1720 provide buffering and packetizing/depacketizing functions, but they need not employ a media codec, and hence reduce the degradation in the quality of the media. SIP signaling, for example, permits for negotiating the best codec present in end-devices and gateways.

Cellular gateways 1740 transcode the media from cellular-media encoding to PSTN voice encoding (e.g., A-Law, Mu-Law). For the purpose of simplicity, cellular gateways 1740 are shown as a function that is allocated to the MSC 1710. In reality, the functions are distributed between the MSC and Base Transceiver Station (BTS, not shown); BTS is associated with the air (radio) interface at or near cellular antenna locations. Also for the sake of simplicity, signaling gateways are not shown.

MTAC Cradle 305 may use the codec already embedded in cellular phone 307 to encode/decode content destined for transmission through IP Networks 110. This may require certain changes to the way functionality and interfaces are structured in cellular handsets. Alternatively, the cradle may contain cellular codecs, which, under the control of Service Platform 435 reduces the number of end-to-end transcoding stages in each session.

In a preferred embodiment, non-transcoding VoIP gateways 1720 also constitute SIP proxies which negotiate codecs with other media gateways (e.g., VoIP gateway 1750) or with SIP endpoints such as “VoIP Device with cellular codec” 1730 and MTAC Cradle 305. This negotiation determines whether transcoding can be eliminated for specific network legs on a session-by-session basis, and may eliminate transcoding end-to-end for at least a subset of such sessions.

In an exemplary application, plain phone 103 wishes to dial a cellular user through a VoIP service. The phone dials a VoIP gateway assigned by a VoIP service provider. The gateway identifies the terminating number as cellular, verifies that non-transcoding service is available to that termination, then negotiates the appropriate cellular codec with a non-transcoding VoIP gateway associated with the terminating side, and initiates the session. In known systems, cellular access networks are connected via PSTN, and multiple transcodings normally occur. Some of that is disappearing in 3G networks, but the connection to SIP endpoints and plain phones is not a part of 3G.

MTAC Cradle 305 may be designed to use the cellular codec already embedded in cellular phone 307. However, this requires the separation of functions (codec from air interface) in the cellular phone, and exposing appropriate physical and logical interfaces in the cellular phone 307 for communicating with MTAC Cradle 305.

Daisy Chaining

In yet another alternate embodiment, the cradles 305, connected to an IP network 115, may be daisy-chained together. In one such embodiment, a first cradle 305 is left at a primary location (e.g., a user's residence) while a second cradle 305 is carried with the user. The user connects the second cradle 305 to the IP network 115 at a different location (e.g., in a foreign country), and instructs the second cradle 305 to authenticate itself to the first cradle 305. Communications may then be sent from the second cradle to the first cradle (and vice versa) using IP communications, but seemingly as if the user were using a telephone connected to the first cradle directly. Such an embodiment may be beneficial in situations where the provider of the voice services will only permit a single unit per subscription fee. Moreover, in such a configuration, the ringing associated with an incoming call can occur at telephones connected to both the first and second cradles 305. When coupled with distinctive ring tones or caller ID, the person on travel can identify which calls are for her/him, and the people still at the primary location can identify which calls are for them. When the telephone connected to the second cradle answers the phone, all communications are forwarded from the first cradle to the second cradle via IP communications.

While specific hardware has been disclosed by way of example and according to the best mode, other implementations are possible. For example, most of the functionality of the disclosed devices can be emulated by using a computer, e.g. a PC, with appropriate interfaces, applications and other software written according to the disclosed steps of operation. The broadband connection could be provided wirelessly (e.g., using the 802.11 or 802.16 standard). In this regard, the MTAC Cradles 305 should include broadband wireless capabilities supplanting or supplementing the other broadband connections disclosed.

Obviously, numerous modifications and variations of the present invention are possible in light of the above teachings. It is therefore to be understood that within the scope of the appended claims, the invention may be practiced otherwise than as specifically described herein.

1-13. (canceled)

14. A multimedia communications method employing a portable multimedia terminal adapter cellular internet protocol gateway (MTAC IPG), between a cellular network and an IP network, comprising:
registering the MTAC IPG with a SIP Proxy;
providing a signaling-and-media-operative connection for a cellular phone that is in separate communication with a cellular network;
in response to a user locally dialing a first dial string that is the number of the cellular phone, signaling the cellular phone to go off-hook;
authenticating the user as an authorized user and thereafter dialing out over the IP network using a second dial string through the cellular phone;
providing gateway functionality between the cellular phone connection and the IP network;
transmitting cellular phone media flows encoded by a cellular phone codec to the IP network; and
packetizing/depacketizing and buffering the media flows as the media flows flow between the cellular and IP networks.

15. The method of claim 14, wherein the step of transmitting comprises transmitting the media flows encoded by the cellular phone codec to pass to the IP network without further coding.

16. The method of claim 15, further comprising disabling any codecs residing in the MTAC/IPG.

17. The method of claim 16, wherein said disabling further includes switching from an MTA IPG mode having an array of codecs, and only broadband IP and PSTN operative connections to an MTAC IPG mode having cellular and broadband IP connections; and
performing IPG operations for the MTA IPG mode the same as performing IPG operations for the MTAC IPG mode, except that said signaling is in response to the user locally dialing the first dial string in from the PSTN for the MTA IPG mode and from a cellular network for the MTAC IPG mode.

18. The method of claim 17, wherein said switching is triggered by signaling indicating a user dialing to the PSTN and the cellular phone being off-hook, respectively.

19. The method of claim 14, further comprising recording MTAC IPG presence information in a database with a geographic association to the current geographical location of the MTAC IPG.

20. The method of claim 14, wherein said authenticating occurs when calls coming into the gateway are from a specific cellular phone or landline and the ANI of the calling phone is used at least as part of the authentication.

21. The method of claim 14, wherein providing said gateway functionality comprises collecting a string of DTMF tones dialed after providing a dial tone to a calling phone.

22. The method of claim 14, further comprising setting up a broadband connection and obtaining an IP address.

23-29. (canceled)

30. A method of transcoding reduction in communicating over an IP network, comprising:
identifying coding capability of a cellular device connected to the IP network; and
signaling setup of a communication session between the cellular device and the IP network with peripheral gateways closest to the cellular device to be selected for compatibility with the cellular device coding capability.

31. The method of claim 30, further comprising:
exchanging communication session media only as encoded by the cellular device without further transcoding between the cellular device and the IP network.

32. The method of claim 31, wherein the steps are performed by a VoIP device.

33. The method of claim 31, wherein the steps are performed by a portable gateway that is not a component of the IP network.

34. The method of claim 31, wherein the steps are performed by a portable, multimedia terminal adapter (MTA).

35. The method of claim 31, wherein said exchanging is free of cellular network transmission.

36. The method of claim 35, wherein the steps are performed by a VoIP device.

37. The method of claim 35, wherein the steps are performed by a portable gateway that is not a component of the IP network.

38. The method of claim 35, wherein the steps are performed by a portable, multimedia terminal adapter (MTA).

39. The method of claim 30, wherein the steps are performed by a VoIP device.

40. The method of claim 30, wherein the steps are performed by a portable gateway that is not a component of the IP network.

41. The method of claim 30, wherein the steps are performed by a portable, multimedia terminal adapter (MTA).

42-68. (canceled)

69. A method of registering a multimedia terminal adapter/cellular internet protocol gateway (MTAC IPG), having a cradle, at a new location, comprising:
in response to the MTAC IPG establishing signaling and media connection with an IP network, obtaining an IP address from a local internet service provider;
recording geographical presence of the MTAC IPG in a geographic association database;
adjusting geography dependent presence conditions in the geographic association database to reflect a new geographic location of the MTAC cradle;
selecting an appropriate set of rules for the new geographic location;
associating a service providers database with the derived geography in the geographic association database and selecting at least one participating cellular carrier at the new presence geographic location;
receiving an identity and capabilities of the cellular phone;
determining a cellular carrier in the geographic region that is compatible with the capabilities of cellular phone;
programing the SIM card of the cellular phone in accordance with the results of said determining;
triggering a test cellular call between the cellular phone and a test number;
reprogramming the SIM card in response to the test call results;
recording the new local cellular phone number.

70. The method of claim 69, further comprising reversing a call direction when the cellular phone is operatively connected to the MTAC IPG in response to a caller hang up.

71. The method of claim 70, further comprising: in response to a signaling indicating that the caller hung up, signaling the cellular phone to go off hook and dial a number of the caller; and ringing another phone that is short range connected to the MTAC IPG for alerting the originally called party.
